(19) United States
(12) Patent Application Publication
(10) Pub. No.: US 2026/0031691 A1
(43) Pub. Date: Jan. 29, 2026

(54) Rotor Balance System And Method for ESP Motors

(71) Applicant: Halliburton Energy Services, Inc., Houston, TX (US)

(72) Inventor: Michael Rimmer, Frimley (GB)

(21) Appl. No.: 18/787,527

(22) Filed: Jul. 29, 2024

(51) Int. Cl. H02K 15/16; H02K 1/27

(52) U.S. Cl. CPC H02K 15/165; H02K 1/27; H02K 2215/00

(57) ABSTRACT

Improved rotor module balancing approaches are disclosed. For example, a rotor module may be configured to be concentrically disposed on a drive shaft of an ESP motor, and may include an active length, as well as a plurality of pockets which each can extend axially into the active length and be configured to retain one of a plurality of balance masses. Such exemplary rotor modules may be balanced by determining a direction and a mass amount representing unbalance of the rotor module; based on that determination, determining specific pockets for receiving the balance masses and the amount of each corresponding balance mass; and inserting the balance masses into the corresponding pockets. Such an approach may allow for quick and efficient rotor balancing, while minimizing length of the rotor module and/or maximizing the ratio of active length versus total length of the rotor module.

### CROSS-REFERENCE TO RELATED APPLICATIONS

None.

### STATEMENT REGARDING FEDERALLY SPONSORED RESEARCH OR DEVELOPMENT

Not applicable.

### FIELD

This disclosure relates generally to the field of pumping. More particularly, this disclosure relates to the field of electric submersible pumps for use downhole in a well. Still more particularly, this disclosure relates to downhole motors of the sort which may be used in electric submersible pumps, and to improved systems and methods for balancing rotors and/or rotor modules for such downhole motors.

### BACKGROUND

Electric submersible pump (ESP) assemblies are used to artificially lift fluid to the surface, for example in deep wells such as oil or water wells. ESP assemblies are commonly used in the oil and gas industry to extract fluids from underground reservoirs. By way of example, the artificial lift provided by ESP assemblies may be useful in situations when the reservoir does not have sufficient energy to allow the well to naturally produce effectively, or when an additional boost to production of the well is desired. Improvements to ESP assemblies can improve overall production of fluids from a well, which may thereby improve the profitability of the well. Improvements in the construction and assembly of the ESP and/or its component parts may result in lower ESP costs and/or in improved characteristics (such as durability or life).

A typical ESP assembly comprises, from bottom to top, an electric motor, a seal unit, a pump intake, and a pump (e.g. typically a centrifugal pump), which are all mechanically connected together with shafts and shaft couplings. The electric motor supplies torque to the shafts, which provide power to the pump. The electric motor is isolated from a wellbore environment by a housing and by the seal unit. In some embodiments, the seal unit can act as an oil reservoir for the electric motor. For example, the oil can function both as a dielectric fluid and as a lubricant in the electric motor. The seal unit also may provide pressure equalization between the electric motor and the wellbore environment.

The pump is configured to transform mechanical torque received from the electric motor via a drive shaft to fluid pressure which can lift fluid up the wellbore. For example, a centrifugal pump typically has rotatable impellers within stationary diffusers. A shaft extending through the centrifugal pump is operatively coupled to the motor, and the impellers of the centrifugal pump are rotationally coupled to the shaft. In use, the motor can rotate the shaft, which in turn can rotate the impellers of the centrifugal pump relative to and within the stationary diffusers, thereby imparting pressure to the fluid within the centrifugal pump. The electric motor is generally connected to a power source located at the surface of the well, for example using a cable and a motor lead extension. The ESP assembly can be placed into the well and usually is disposed inside a well casing. In a cased completion, the well casing separates the ESP assembly from the surrounding formation. In operation, perforations in the well casing allow well fluid to enter the well casing and flow to the pump intake for transport to the surface.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of an exemplary electric submersible pump (ESP) assembly disposed in a wellbore, according to an embodiment of the disclosure;

FIG. 2 is a cross-sectional view of an exemplary motor for the electric submersible pump assembly of FIG. 1, according to an embodiment;

FIG. 3 is an exploded isometric view of the motor of FIG. 2, according to an embodiment of the disclosure;

FIG. 4 is a partial cut-away isometric view of an exemplary ESP motor having a plurality of rotor modules with rotor bearing assemblies therebetween, according to an embodiment of the disclosure;

FIG. 5 is an isometric view of an exemplary rotor assembly for an ESP motor of an ESP pump assembly, according to an embodiment of the disclosure;

FIG. 6A is a side view of an exemplary rotor module for an exemplary rotor assembly, according to an embodiment of the disclosure;

FIG. 6B is a radial cross-sectional view of the rotor module of FIG. 6A, according to an embodiment of the disclosure;

FIG. 7A is a side view of another exemplary rotor module embodiment similar to that of FIG. 6A but having additional balance planes, according to an embodiment of the disclosure;

FIG. 7B is a cross-sectional view of two exemplary embodiments of a balance plane of the sort used in FIG. 7A, according to an embodiment of the disclosure;

FIG. 7C is a schematic end view of the axial balance plane embodiment of FIG. 7B, according to an embodiment of the disclosure;

FIG. 8 is a radial cross-sectional view of yet another exemplary rotor module, according to an embodiment of the disclosure;

FIG. 9 is a radial cross-sectional view of still another exemplary rotor module, according to an embodiment of the disclosure;

FIGS. 10A-C illustrate exemplary pocket variants at exemplary balance positions in an exemplary rotor module, according to an embodiment of the disclosure;

FIG. 11A is a radial cross-sectional view of yet another exemplary rotor module (e.g. similar to FIG. 8, but with pockets and/or balance positions), according to an embodiment of the disclosure;

FIG. 11B illustrates an alternate exemplary insert for the rotor module embodiment of FIG. 11A, according to an embodiment of the disclosure;

FIG. 11C is a side view of the rotor module embodiment of FIG. 11A, according to an embodiment of the disclosure;

FIG. 11D is an isometric view of the rotor module of FIG. 11A schematically illustrating insertion of one or more balance masses into pockets of the rotor module, according to an embodiment of the disclosure;

FIG. 12A is a radial cross-sectional view of still another exemplary rotor module (e.g. similar to FIG. 9, but with pockets and/or balance positions), according to an embodiment of the disclosure;

FIG. 12B is a side view of the rotor module embodiment of FIG. 12A, according to an embodiment of the disclosure;

FIG. 12C is a side view of an alternate embodiment of a rotor module similar to that of FIG. 12B in which the pockets each extend from the corresponding end of the rotor module for less than half of the length of the rotor module, leaving a central portion of the active length of the rotor module without pockets extending therein, according to an embodiment of the disclosure;

FIG. 13 is a radial cross-sectional view of yet another exemplary rotor module (e.g. for a synchronous reluctance rotor), according to an embodiment of the disclosure;

FIG. 14 is a radial cross-sectional view of still another exemplary rotor module (e.g. for a switch reluctance (e.g. 8-pole) rotor), according to an embodiment of the disclosure;

FIG. 15 is a radial cross-sectional view of yet another exemplary rotor module (e.g. for a 2-pole hybrid PMM rotor), according to an embodiment of the disclosure;

FIG. 16 is a radial cross-sectional view of still another exemplary rotor module (e.g. for an exemplary induction motor rotor), according to an embodiment of the disclosure;

FIG. 17 is a radial cross-sectional view of yet another exemplary rotor module (e.g. for an exemplary 2-pole PMM motor rotor), illustrating exemplary pocket positioning according to an embodiment of the disclosure;

FIG. 18 is a radial cross-sectional view of still another exemplary rotor module (e.g. for an exemplary 2-pole PMM motor rotor similar to FIG. 17, but illustrating exemplary alternate pocket positioning), according to an embodiment of the disclosure;

FIG. 19 is a radial cross-sectional view of yet another exemplary rotor module (e.g. for an exemplary induction motor rotor similar to FIG. 16, but illustrating exemplary alternate pocket positioning), according to an embodiment of the disclosure;

FIG. 20A is an isometric view illustrating an exemplary balance mass (e.g. configured for insertion into a pocket of an exemplary rotor module, for example in a manner similar to that shown in FIG. 11D and/or to help balance the rotor module), according to an embodiment of the disclosure;

FIG. 20B is an isometric view of another exemplary balance mass (e.g. similar to FIG. 20A but also having threading), according to an embodiment of the disclosure;

FIG. 20C is an isometric view of yet another exemplary balance mass (e.g. similar to FIG. 20A, but also comprising multiple balance mass segments), according to an embodiment of the disclosure;

FIG. 21A is a schematic view of an exemplary rotor module (e.g. having four balance positions and/or pockets, which are evenly spaced around the axis of the rotor module and/or the drive shaft, for example with 90 degrees therebetween), according to an embodiment of the disclosure;

FIG. 21B is a schematic view of another exemplary rotor module (e.g. having four balance positions and/or pockets, which are unevenly spaced around the axis of the rotor module and/or the drive shaft, for example with 60 degrees between some adjacent pockets and 120 degrees between other adjacent pockets), according to an embodiment of the disclosure;

FIG. 22 is a schematic view of an exemplary rotor module, illustrating an exemplary mass-splitting approach (e.g. for determining the specific pockets and/or specific masses for insertion of the balance masses to help balance the rotor module), according to an embodiment of the disclosure; and

FIG. 23A-B are schematic views of an exemplary rotor module, illustrating an exemplary mass-splitting approach (e.g. similar to that of FIG. 22, but for higher pole count rotor modules), according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

Disclosed embodiments relate generally to improved techniques for forming/assembling rotor assemblies. More specifically, disclosed embodiments may relate to rotor assemblies for an ESP motor (e.g. for use with a pump to form an ESP assembly for use downhole in a well to pump formation fluids from the well formation to the surface), and to improved systems and methods for balancing such rotor modules.

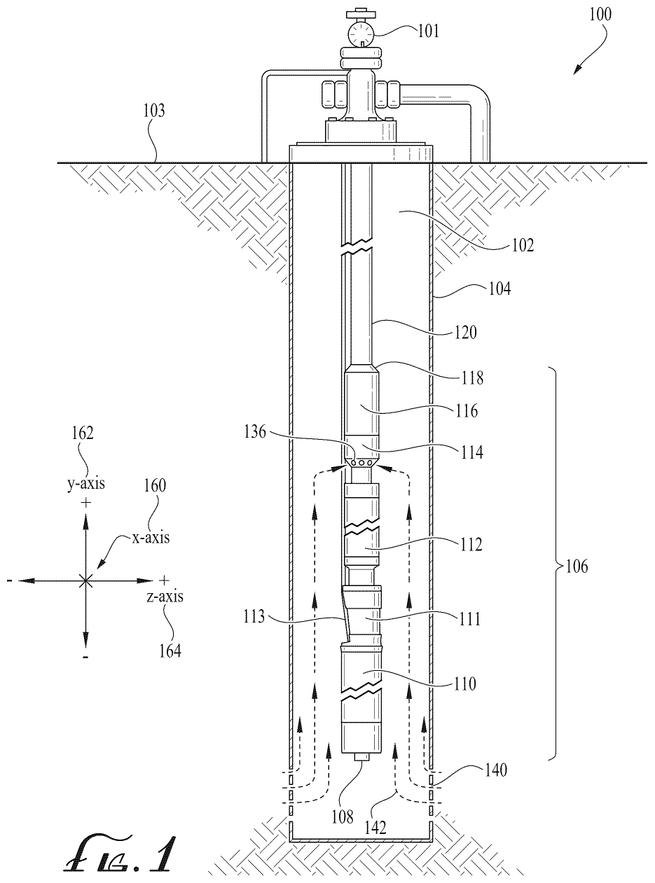

Turning now to FIG. 1, an exemplary producing well environment 100 is described. In an embodiment, the environment 100 comprises a wellhead 101 above a wellbore 102 located at the surface 103. A casing 104 is provided within the wellbore 102. For convenience of reference, FIG. 1 provides a directional reference comprising three coordinate axes—an X-axis 160 where positive displacements along the X-axis 160 are directed into the sheet and negative displacements along the X-axis 160 are directed out of the sheet; a Y-axis 162 where positive displacements along the Y-axis 162 are directed upwards on the sheet and negative displacements along the Y-axis 162 are directed downwards on the sheet; and a Z-axis 164 where positive displacements along the Z-axis 164 are directed rightwards on the sheet and negative displacements along the Z-axis 164 are directed leftwards on the sheet. In the embodiment of FIG. 1, the Y-axis 162 is approximately parallel to a central axis of a vertical portion of the wellbore 102.

An exemplary electric submersible pump (ESP) assembly 106 is deployed downhole in a well within the casing 104 and comprises an optional sensor unit 108, an electric motor 110 which may include a motor head 111, a seal unit 112, an electric power cable 113, a pump intake 114, a centrifugal pump 116, and a pump outlet 118 that couples the centrifugal pump 116 to a production tubing 120. The centrifugal pump 116 is operatively coupled to the motor 110 by a shaft (not shown). In an embodiment, the ESP assembly 106 may employ thrust bearings in several places, for example in the electric motor 110, in the seal unit 112, and/or in the centrifugal pump 116. While not shown in FIG. 1, in an embodiment, the ESP assembly 106 can comprise a gas separator that may employ one or more thrust bearings. The motor head 111 couples the electric motor 110 to the seal unit 112. The electric power cable 113 may connect to a source of electric power at the surface 103 and to the electric motor 110, for example being configured to provide power from the source of electric power at the surface 103 to the electric motor 110.

In operation, the casing 104 is pierced by perforations 140, and reservoir fluid 142 flows through the perforations 140 into the wellbore 102. The fluid 142 flows downstream in an annulus formed between the casing 104 and the ESP assembly 106, is drawn into the pump intake 114, is pumped by the centrifugal pump 116, and is lifted through the production tubing 120 to the wellhead 101 to be produced at the surface 103. The fluid 142 may comprise hydrocarbons such as oil and/or gas, water, or both hydrocarbons and water.

While the example illustrated in FIG. 1 relates to land-based subterranean wells, similar ESP systems can be used in a subsea environment and/or may be used in subterranean environments located on offshore platforms, drill ships, semi-submersibles, drilling barges, etc. And while the wellbore is shown in FIG. 1 as being approximately vertical, in other embodiments, the wellbore may be horizontal, deviated, or any other type of well. Also, while the pump of the ESP is described with respect to FIG. 1 as a centrifugal pump, other types of pumps (such as a rod pump, a progressive cavity pump, any other type of pump suitable for the system, or combinations thereof) may be used instead.

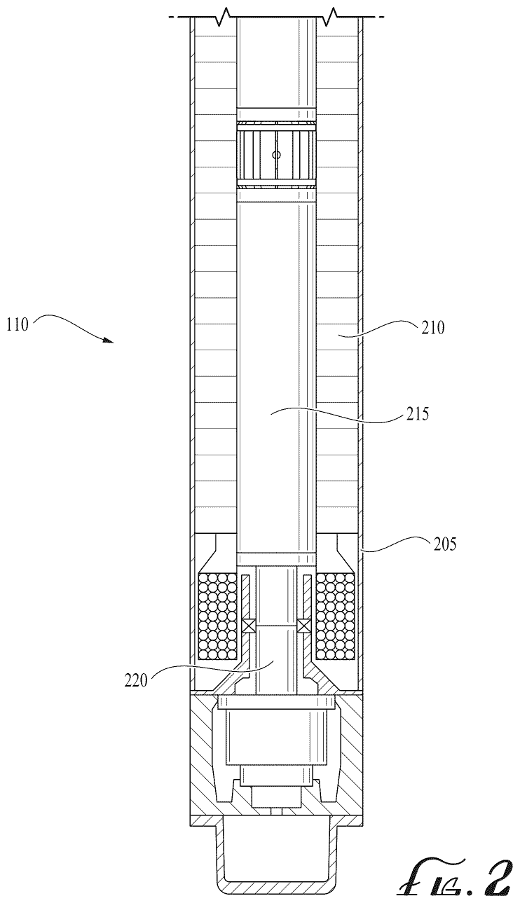

As shown in FIGS. 2-3, an exemplary motor 110 of the ESP assembly includes a housing 205, a stator 210, a rotor 215, and a drive shaft 220. The housing 205 typically comprises a hollow cylinder or tube and is configured to protect the internal components of the motor 110 from the external environment. The stator 210 also typically comprises a hollow cylinder and is secured to the housing 205 (e.g. to the inner surface of the housing 205) so as to be stationary within the housing 205. Typically, the stator 210 comprises a plurality of laminations, which may be thin sheets of steel, iron, or bronze, wrapped by a plurality of electrically conductive windings. When energized, the windings can generate a rotating magnetic field for interaction with the rotor 215 to induce rotation of the rotor 215. The rotor 215 also typically comprises a hollow cylinder and is concentrically arranged between the stator 210 and the drive shaft 220, for example with the drive shaft 220 typically extending longitudinally along the centerline of the motor 110, the rotor 215 disposed around the drive shaft 220, and the stator 210 disposed around the rotor 215, within the housing 205. The rotor 215 is rotatable within the stator 210 and secured to the drive shaft 220, such that rotation of the rotor 215 drives the drive shaft 220. In embodiments, the motor 110 may be a two or more pole motor, a three-phase squirrel cage induction motor, a permanent magnet motor (PMM), a hybrid PMM, or other motor configuration.

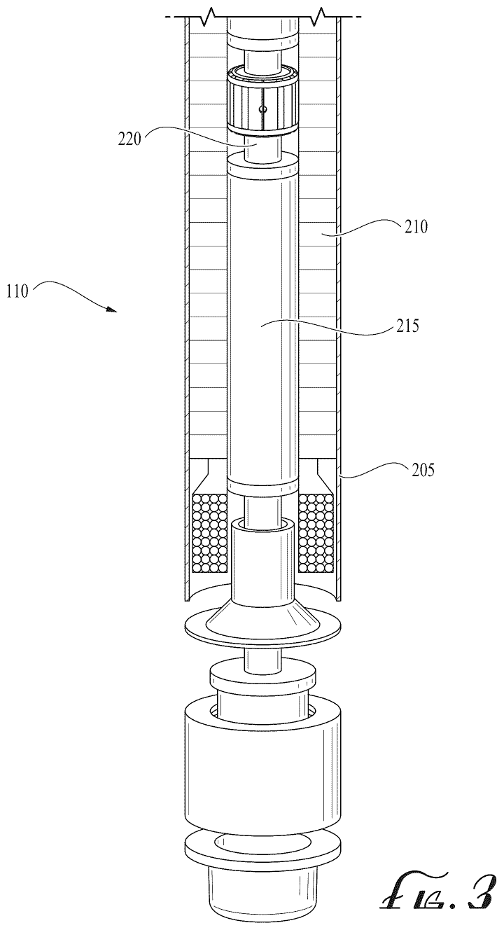

Depending on the power requirements of the motor 110, the rotor 215 can be an assembly which typically includes a number of rotor modules, which together jointly form the rotor assembly 215, with each rotor module secured to the drive shaft 220. The rotational magnetic field of the stator 210 when energized can induce rotation of the rotor 215, and thereby the drive shaft 220, with the drive shaft 220 transmitting rotational torque from the motor 110 to the pump 116. As shown in FIG. 4, the rotor modules 405 (jointly forming the rotor 215) are spaced apart from each other along the drive shaft 220, with a rotor bearing assembly 410 typically located between adjacent rotor modules 405. Rotor bearing assemblies 410 can also be located at the top of the uppermost rotor module 405 and/or the bottom of the lowermost rotor module 405 (e.g. at the top and bottom of the rotor). In some embodiments, the rotor bearing assembly 410 can be a hydrodynamic bearing assembly. Each rotor bearing assembly 410 is configured to support the rotor 215 at predefined axial positions to maintain correct radial alignment of the drive shaft 220 during motor operation.

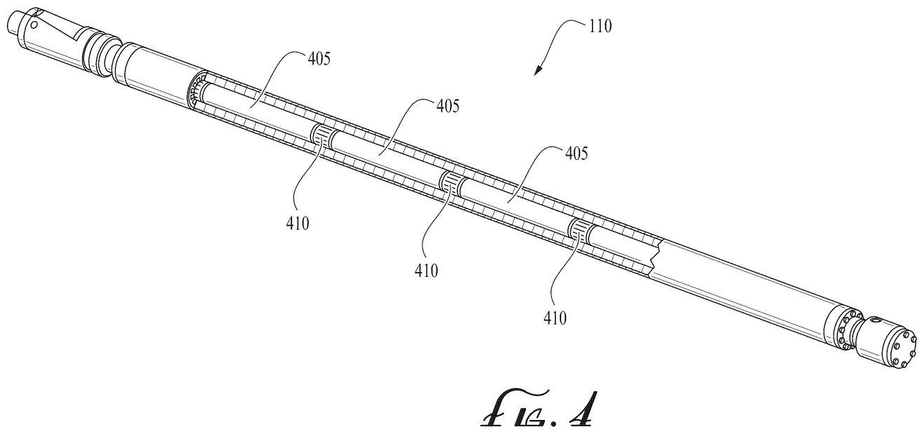

FIG. 5 illustrates a typical rotor assembly 215 of an electric motor 110 (for example, of an ESP assembly). In embodiments, the electric motor 110 can be a permanent magnet motor. Typically, the rotor assemblies 215 shown in the figures belong to such a permanent magnet motor (PMM). However, alternate embodiments may include an electric motor of any conventional type, i.e. an induction motor or a hybrid PMM containing elements of both permanent magnet and induction motors. The rotor assembly 215 of the PMM utilizes permanent magnets to generate the electromagnetic field, compared to induction motors where the magnetic field is generated by inducing a current in rotor interconnected bars (e.g. rotor/cage bars), which may be made from copper.

A rotor assembly 215 embodiment can comprise a single drive shaft 220, a plurality of magnetic rotor modules 405, and a plurality of radial hydrodynamic bearing assemblies 410. Typically, a bearing assembly 410 can be disposed between adjacent rotor modules 405. In embodiments, the rotor assembly 215 can also include a pre-loading mechanism 505 (as shown in FIG. 5), which can provide thermal expansion compensation for the rotor assembly 215. In the embodiment shown in FIG. 5, the pre-loading mechanism 505 is disposed at the non-drive end (e.g. the motor base) of the rotor assembly 215, and it can be configured to act against the gravitational load 520 created by all the rotor modules 405 and journal bearing assemblies 410 installed on the shaft 220 (as well as addressing differential thermal expansion, for example). Alternatively, or in conjunction, the pre-loading mechanism 505 can be positioned at the drive end (e.g. the motor head) of the shaft 220, according to other embodiments.

For rotors to work most effectively, the rotor should have low unbalance. For example, unbalanced rotors will lead to increased motor vibration, which can reduce run life of the motor and other ESP string components (e.g. due to increased wear). Additionally, improvements to rotor balance may allow for increased operational speeds for the motor. Accordingly, ISO/API standards exist with regard to rotor balance, and further improvements to rotor balance may prove even more beneficial.

Unfortunately, there are several issues which can make rotor balancing difficult. For example, in permanent magnet motors (PMM), the permanent magnets that are used in the rotors may have subtly different mass per volume, for example due to tolerances of the sintering process used in their manufacture. As a high number of magnets can be used per rotor module, there can be a significant effect of creating unbalance where the mass of magnet on one side of the rotor differs from the other. On Hybrid PMM motors, the problem can be further exacerbated by the cage structure, for example since the copper bars of the cage structure may also be of subtly different weight causing a similar compounding issue. Additionally, the rotor unbalance may be made worse by inherent radial height difference (eccentricity) from side to side on the rotor. Overall, these sorts of effects can lead to high unbalances, which can negatively impact rotor and/or motor performance and/or runlife.

Vibration standards, such as API and ISO, typically specify a vibrational limit on the measured vibration of downhole rotating equipment. This may be expressed in terms of the vibrational speed (e.g. in units of inch/s or mm/s). For instance, ISO specifies various vibration limits, or “balance grades” (e.g. G1, G2.5, G6.3 etc.), which specify a maximum allowable vibration (e.g. of 1 mm/s, 2.5 mm/s and 6.3 mm/s respectively). API typically specifies a maximum limit of 3.96 mm/s for downhole rotating equipment, such as motors.

Unbalance (U) can be directly expressed in terms of mass (m in grams, g) and a radius (r in mm) with ISO units of g·mm:

$$U = m \times r$$

Per ISO, the balance requirements (or maximum allowable unbalance U_{MAX} in g·mm) of a rotor can be directly computed based on the rotors mass (mᵣₒₜ in kg), the target balance grade (G in mm/s) and the rotation speed in RPM using the equation:

$${U}_{MAX} = \frac{9549 \times {m}_{rot} \times G}{RPM}$$

In turn U_{MAX} can be used to express the maximum radial offset, termed “eccentricity” (e), in μm (microns) of the rotor mass (mᵣₒₜ) using the unbalance equation above as

$$e = \frac{{U}_{MAX}}{{m}_{rot}} = \frac{9549 \times G}{RPM}$$

By way of example, taking a typical PMM rotor module weighing ˜20 kg, with a balance grade of G3.96 and an operating speed of 3600 rpm the equations can be used to give:

$${U}_{MAX} = \frac{9549 \times 20 \times 3.96}{3600} = 210 g . mm$$

$$e = \frac{9549 \times 3.96}{3600} = 10.5 μm$$

Accuracies in machining, forming, sintering or similar formation of parts are typically much greater than 25 μm. Additionally, tolerances during assembly can compound as parts are assembled together. Therefore, balance eccentricity of 10.5 μm may not be readily achievable by dimensional control of the rotor.

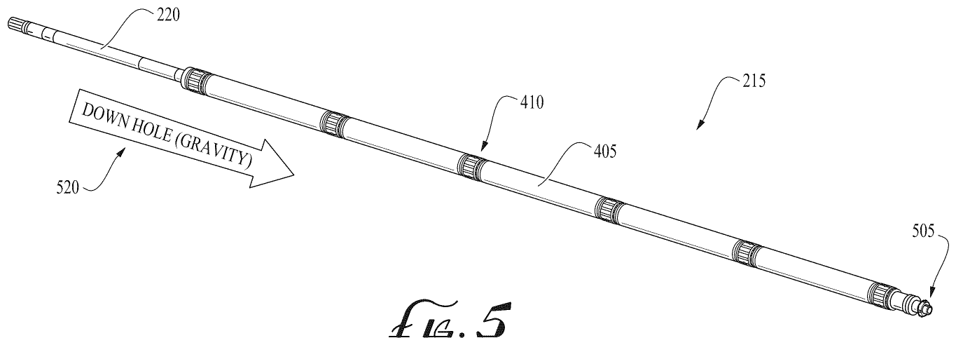

FIGS. 6A-B illustrate an exemplary rotor module 405, for example an exemplary hybrid PMM motor module, which may be considered with regard to balance issues. The rotor module 405 of FIG. 6A has an active length 61, which can be the axial length of the portion of the rotor module 405 configured for magnetic interaction with a corresponding stator, for example to drive the drive shaft, and/or the portion of the rotor module 405 operating (e.g. with the stator) to generate torque. In FIGS. 6A-B, the volume of magnets 5 may typically be controlled by 3 dimensions representing a height (h), width (w) and length (l). Additionally, the density of the sintered material forming the magnets 5 will often vary. This can result in significant variability in the mass of the magnets 5 of ˜mass=density×length×height×width; and the resulting unbalance effect, based on the radius (r) to the magnet's center of gravity may be characterized as ˜unbalance=density×length×height×width×radius. As an example, if each dimension varies by ±1%, the mass can vary by ±4% and the unbalance effect by ±5%. By way of example, if the magnets 5 on one side of the rotor module 405 are at the lower bound (−5%), and the magnets 5 on the opposite side are at the upper bound (+5%), an exemplary worst-case unbalance effect on the rotor module 405 may be ±10%. A similar issue of variability can occur with the rotor cage (e.g. comprising the rotor/cage bars 22 in FIG. 6B), where the masses of the rotor cage bars 22 may be distributed unevenly.

In practice for the typical rotor module, unbalances have been found to be on the order of approximately 2000-5000 g·mm, such that exemplary rotors may be 10-25 times outside of the required balance grade. Thus, rotor module balancing is likely required to achieve a desired standard, such as G3.96 ISO grade requirement, in a typical assembled motor. Consequently, additional approaches may be needed to achieve the desired rotor balance.

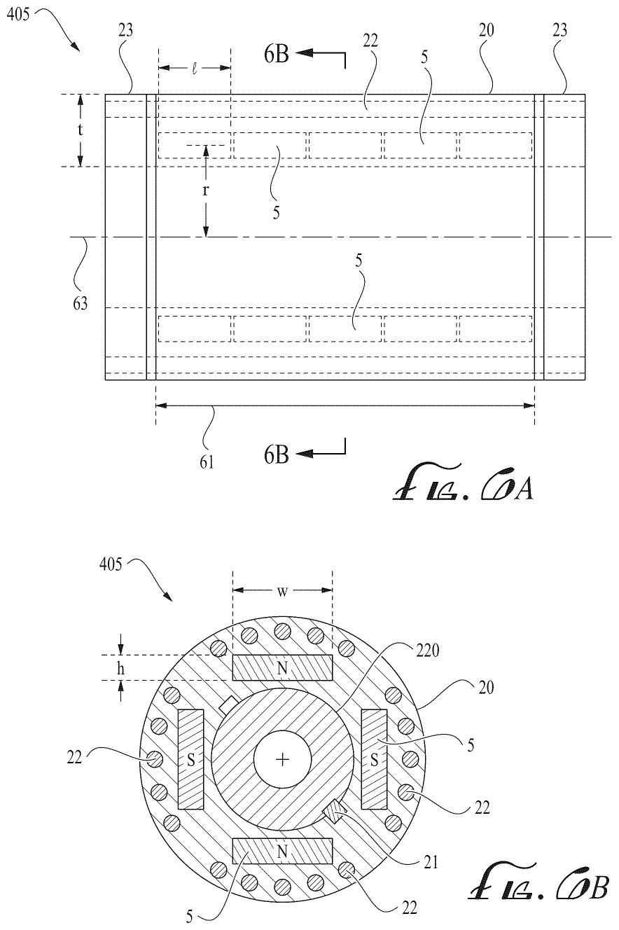

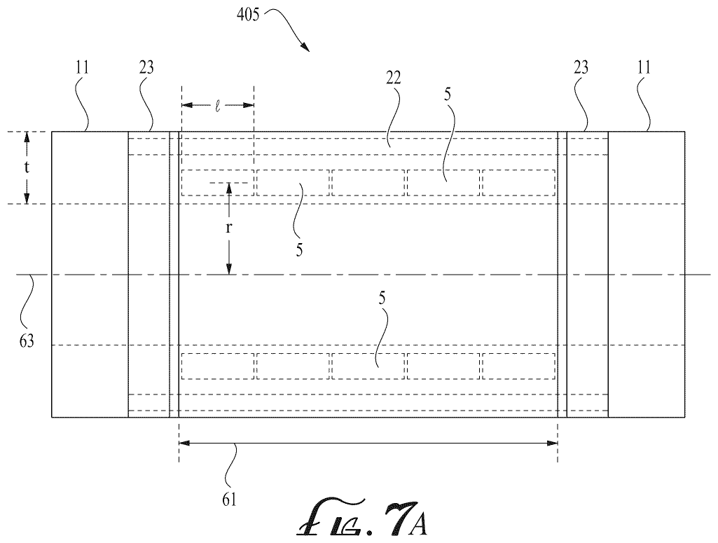

One exemplary approach for rotor balancing may be to add mass (e.g. by addition of grub screws or solid rod to a hole) or subtract mass (by drilling holes) into a balance plane 11, which may be an additional section (e.g. a non-active section having axial length) in addition to the active length 61 of the rotor module 405 (see for example FIGS. 7A-C). These balance planes 11 are typically located at each end of a rotor module 405, and thus the unbalance correction is typically distributed to each end of the rotor module 405 (e.g. for the example above 1000-2500 g·mm per plane). For the typical ESP rotor module 405, the balance hole radius can be on the order of 15 to 50 mm. In the example given, assuming a 42 mm balance hole radius, between 48 g to 119 g of mass addition or removal may be required based on the unbalance (m=U/r). At an exemplary radius of 42 mm, an exemplary balance plane 11 can fit a total of approximately 24 axially-oriented balance positions 6 (e.g. a tapped hole or a drill hole location) spaced at 15° per FIG. 7C (although, the number of balance positions is determined by the overall design, so in other embodiments any number is possible). Half of these balance positions 6 in FIG. 7C cannot be used, as the weight addition or removal must be on the side of the rotor module 405 of the correction direction 7 for balancing effect, resulting in a maximum of 12 balance positions for this exemplary rotor module balance plane 11. If the unbalance is rotated by half the angular spacing between holes then only 11 holes may be useable. A further issue is that as the balance positions angle away from the correction direction 7, the effect of the mass is reduced to the cosine of the angle (e.g. as shown in FIG. 7C). For example, the sum of balance position corrections represents 63.8% of the added/removed mass in the case of the 12 balance positions shown in FIG. 7C. Consequently, for a 6 mm diameter steel rod (e.g. for addition of mass in the balance plane 11) or hole (e.g. for subtraction of mass in the balance plane 11), the length/depth for each can be calculated as between 12 and 30 mm to achieve the required balance correction. Per FIG. 7A, an exemplary rotor module 405 can be on the order 300-800 mm long (e.g. total length). In a typical example, the length of the rotor module may be approximately 600 mm. When the holes are oriented axially (see for example the axial embodiment of FIG. 7B), the balance plane 11 needs to be at least the length of the maximum hole, and with two balance planes 11 of 30 mm at each end of the rotor module 405, this can represent approximately 60 mm of length. As a result, balance planes 11 for an exemplary rotor module 405 may occupy approximately 10% of the rotor module 405 length. This can have implications for an increased motor length, loss of motor power density, a potentially worse motor power factor and efficiency. Also, the sheer number of drilled holes or added masses may mean that assembly/manufacture becomes time consuming and adds to the manufacturing cost.

Similar issues may arise with respect to a radial approach using balance planes 11 with radially drilled balance holes in each balance plane (see for example the radial embodiment of FIG. 7B), where the radial thickness of the rotor module 405 may be insufficient to drill the explementary 12 mm to 30 mm hole. For instance, the radial thickness 13 of a rotor module 405 is typically no more than 22 mm. Additionally, the deeper portion of the hole has less effect, due to the radial change in height. Consequently, for the same example of 6 mm holes drilled in a module, the worst-case balance would require 2 axially disposed rows of 12 holes of depth 21.8 mm. This can cause a similar issue of making the balance planes 11 undesirable and adding manufacturing cost.

PMM rotors are typically long and of low diameter, which may result in only short local positions at which to add balance planes. Attempting to make the balance planes 11 added to the rotor module 405 too long can result in a loss of active length in the motor (e.g. since a significant portion of the overall length of the rotor may be taken up by balance planes 11, which do not serve as active portions of the motor, e.g. for generating torque), and thus loss of output and efficiency.

Additionally, the drilling option (e.g. to subtract mass from balance planes 11) may produce metal shavings and cuttings. Since PMM parts are typically constructed of magnetic materials, the metal shavings and cuttings may be attracted to the magnetic rotor surfaces and stick, becoming a challenge to remove and adding a further time consuming and costly assembly process. The strong attraction prevalent in permanent magnet rotor modules 405 can also lead to a safety issue, as these assemblies typically attract equipment such as drills and drill bits, which would be used to create holes in the subtract mass approach.

To overcome or address one or more of these types of issues, alternate disclosed embodiments may use a through hole add mass rotor balance approach. For example, the rotor module 405 may be balanced without additional balance planes by adding a length of solid rod (e.g. a balance mass), for example in pockets positioned inside and typically passing through the entire magnetic length (e.g. active length 61) of the rotor module 405. Thus, the balance masses (e.g. solid rods) may extend (e.g. axially) into the active length 61 of the rotor module 405. For example, the pockets can be disposed in the lamination structure supporting the magnets, for example in the interpolar spaces in some embodiments (as discussed below). Some embodiments may use 4 (or more) positions configured for addition of mass (e.g. four or more pockets extending axially into the active length 61 of the rotor module 405 and each configured to receive a balance mass). By adding mass within the active length 61 of the rotor module 405, rotor balancing may be achieved while maximizing the active length of the rotor as a whole (which may for example allow for shorter rotors to be effective). This may address many of the concerns discussed above with either the addition or subtraction of mass balance plane approach.

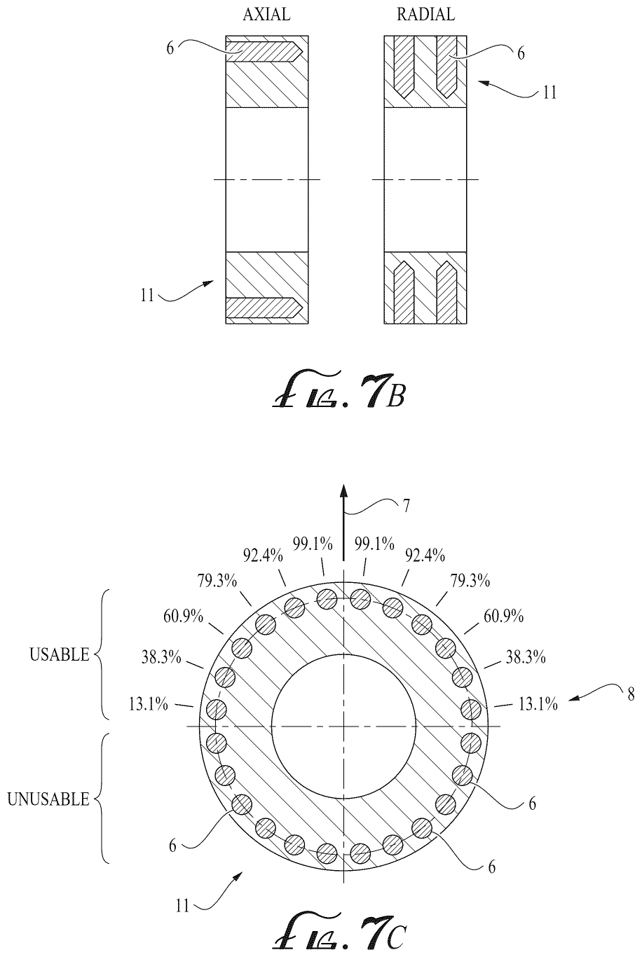

FIG. 8 illustrates an exemplary 4-Pole PMM. The example of FIG. 8 illustrates a surface mount design, in which the magnets 5 are mounted to a magnet carrier 17, which can be mounted to the drive shaft 220, for example with a key 21 configured to provide anti-rotation (e.g. to fix the rotation of the rotor module 405 to that of the shaft 220). In other embodiments the magnet carrier 17 and shaft 220 can be the same part (e.g. the magnet carrier can be integral with the shaft 220 and/or the shaft 220 can be formed to serve as the magnet carrier). In some embodiments, a retainer 19 may optionally be present to hold the magnets 5 to the magnet carrier 17. For example, the retainer 19 may be concentrically disposed around the magnets 5, the magnet carrier 17, and/or the drive shaft 220. FIG. 9 illustrates another exemplary rotor module 405, which is a hybrid PMM rotor module (e.g. in which magnets 5 are mounted into a lamination stack 20). In FIG. 9, rotor/cage bars 22 (e.g. configured for induction) also pass through the lamination stack 20 and can be electrically connected to cage ends 23 (see FIG. 6A-B for example) to create a squirrel cage (per an induction motor).

In the exemplary 4-pole magnetic rotor configurations of FIGS. 8-9, the design can include interpolar spaces 16. These are typically designed to create a flux barrier 23 to prevent the magnetic flux short cutting from the north magnet to the south through the rotor module 405, without linking through the stator windings. These flux barriers 23 are typically designed as non-magnetic voids. This void can be an air gap, oil gap or made from any suitable non-magnetic material (e.g. stainless steel, copper, titanium, tungsten, tungsten carbide, polymer, adhesive, potting compound etc.). The flux barrier 23 can also be a combination of air gaps (no material) and thin magnetic webs to provide structural support but designed to limit the leakage of flux.

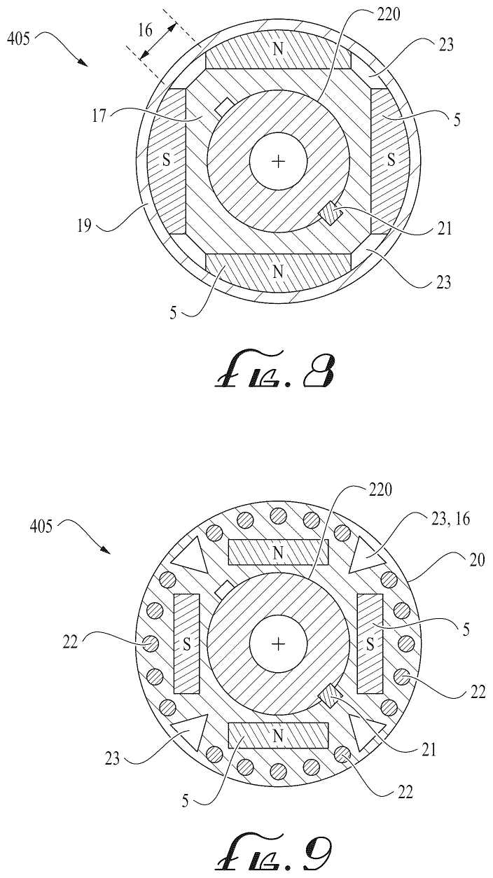

In embodiments, a pocket 24 can be disposed in one or more interpolar space/region 16, and configured to accept a rod of material (e.g. a balance mass 73, see below) to become a balance position 6 for the rotor module 405. The pocket 24 can be part of the flux barriers 23, whose design is driven by electromagnetic considerations, but also can serve as a balance position 6 for the rotor module 405. In many PMM motors (e.g. see FIG. 8) and hybrid PMM motors (e.g. see FIG. 9), the magnets 5 can be held within a laminated structure, and the pockets 24 can be directly stamped into the lamination. In some embodiments this can be a simple hole, although in other embodiments it may be any suitable shape to accept or hold the balance mass 73 (e.g. triangular, square, circular, polygonal, diamond, vee-shaped, c-shaped, threaded hole etc.). The pocket 24 may be designed to support and/or retain the assembled balance mass 73, for example so that it cannot move inside the corresponding pocket 24. Some exemplary geometries of the pocket 24 are shown in FIGS. 10A-C. Assembly of the lamination stack 20 can create a plurality of pockets 24 each extending axially (e.g. into the active length 61), for example along the entire length of the rotor module 405.

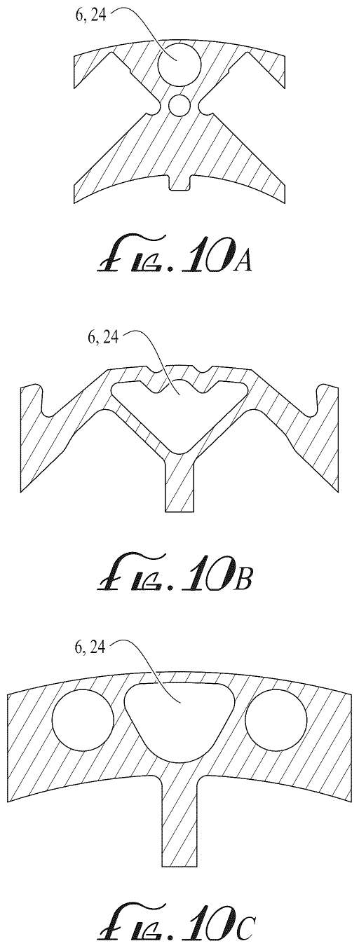

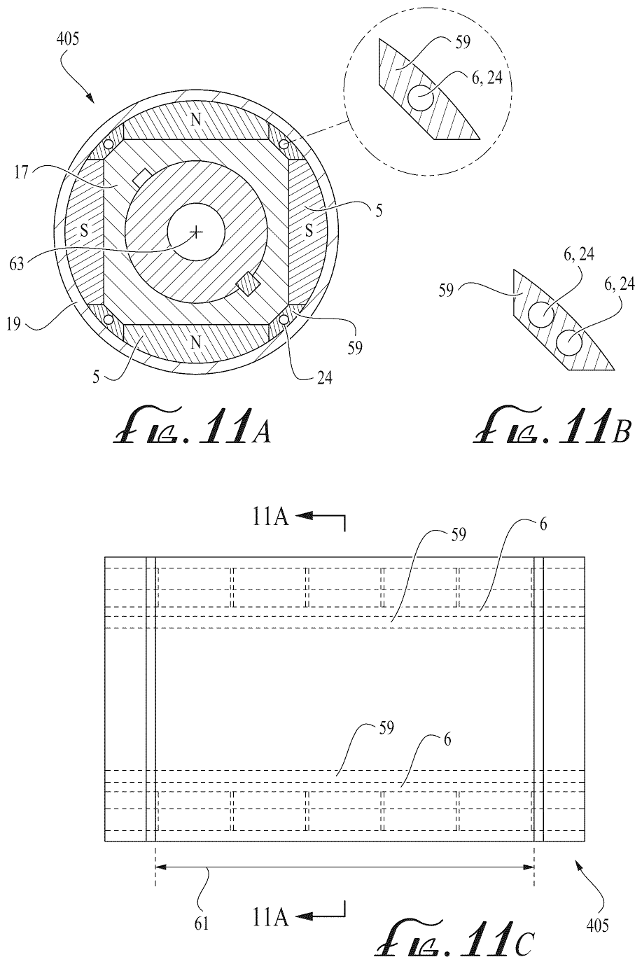

FIGS. 11A-D illustrate an exemplary rotor module 405 having such pockets 24 each configured to receive a balance mass 73 and extending axially within the active length 61 of the rotor module 405 (e.g. its entire length). The exemplary rotor module 405 shown in FIGS. 11A-D is configured as a surface mount PMM. In some embodiments, each interpolar region may comprise a solid non-magnetic insert 59 with a suitable channel drilled/manufactured through it to once again make a pocket 24 that extends into the active length 61 (e.g. at least half and up to the entire length of the rotor module 405). In some embodiments the insert 59 may be subdivided along the length and or width to ease manufacture. In some embodiments the pocket 24 may be formed from the void created by omitting the solid non-magnetic insert 59 altogether. In some embodiments, the pockets 24 may be punched or drilled in the lamination, the insert, and/or the magnet.

As shown in FIG. 11A, the pockets 24 may be disposed around the drive shaft 220, for example creating a balance position 6 at approximately every 90° about the axis 63 of the rotor module 405 (which may be approximately parallel to the drive shaft 220). This concept can be extended to higher pole counts, e.g. 6-pole, 8-pole, 12-pole etc. with a corresponding number of interpolar spaces and pockets. Also note, the number of pockets 24 does not need to match the number of interpolar spaces 16 (e.g. an 8-pole rotor with interpolar gaps at every 45° could still have 4 pockets disposed at every) 90°. In other embodiments, and dependent on geometry, there can be more than one pocket 24 at each balance position 6 and/or in each insert 59 (see for example FIG. 11B). FIG. 11D illustrates insertion of one or more exemplary balance mass 73 (e.g. two balance masses) into the corresponding pocket 24, for example as part of the balancing process for the rotor module 405. Embodiments may have 3-16 pockets (e.g. extending through the length of the rotor module or disposed at each end), for example with higher numbers due to more poles in the motor (e.g. 6-pole, 8-pole etc.) or to having multiple pockets at each interpolar location.

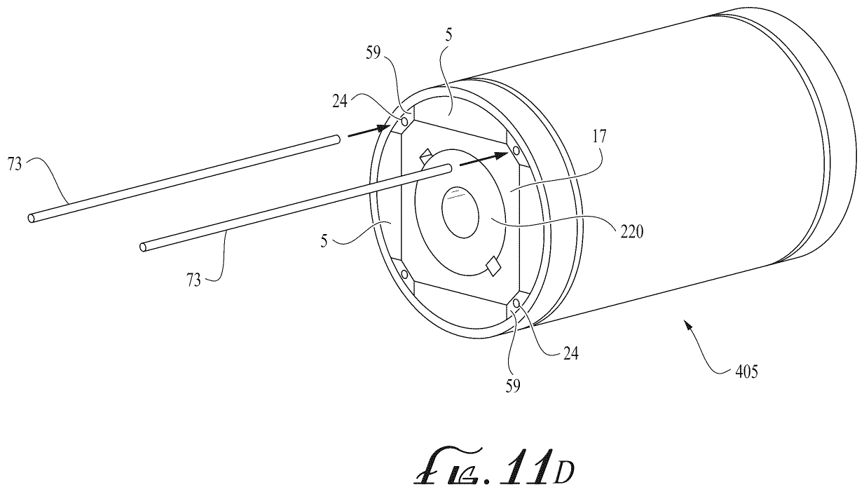

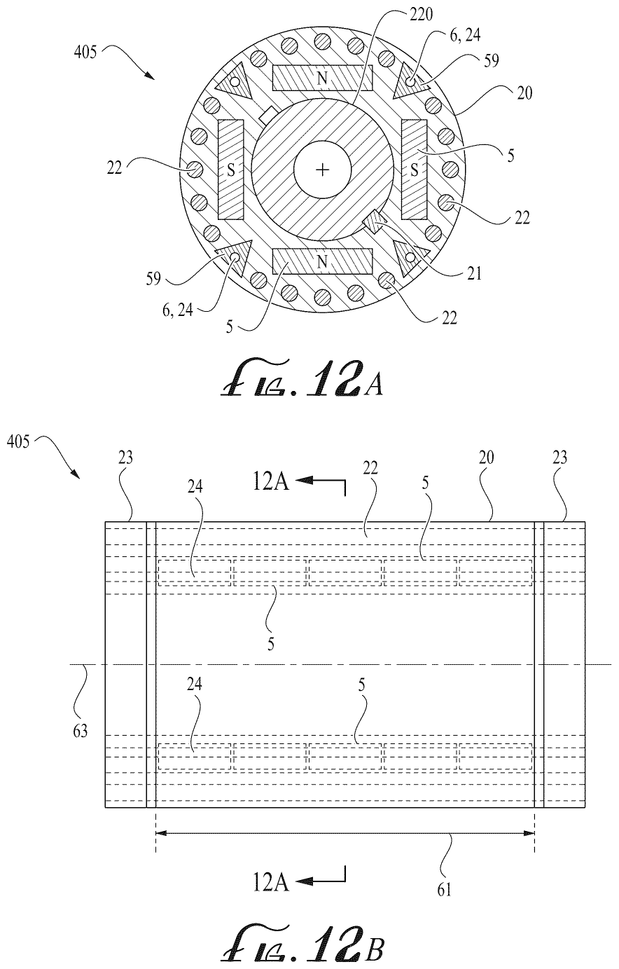

FIGS. 12A-B illustrate another exemplary rotor module 405, which has been configured as a hybrid PMM. Similar to the discussion regarding FIGS. 11A-D, the hybrid rotor module 405 of FIGS. 12A-B has a plurality of pockets 24, each extending axially into the active length 61 of the rotor module 405. In embodiments, each pocket 24 may extend axially approximately parallel to the axis 63 and/or drive shaft 220. Each pocket 24 may be configured to contain/retain a balance mass 73 (e.g. allowing insertion of a balance mass 73 into the corresponding pocket 24). In some embodiments, each pocket 24 may be disposed in the interpolar space 16 and/or flux barrier 23 (for example, with the pocket 24 formed in an insert 59 disposed therein). The plurality of pockets 24 can be configured to be disposed around the drive shaft 220 and/or the longitudinal axis 63 of the rotor module 405.

In embodiments, each pocket 24 may extend up to half of the overall length of the rotor module 405 (e.g. from ¼ to ½ the overall length of the rotor module), at least half of the active length 61 of the rotor module 405, between half and the entire active length 61, or the entire active length 61 of the rotor module 405 (for example the entire length of the rotor module 405). In some embodiments, one or more pocket 24 (e.g. typically a plurality of pockets 24) could extend (e.g. axially and/or into the active length) from each end of the rotor module 405, with each such pocket 24 extending up to half of the overall length of the rotor module (and if pockets from opposite sides/ends are aligned, they may jointly form a single pocket with a total pocket length no more than the overall length of the rotor module in some embodiments, for example a pocket 24 extending the entire length of the rotor module 405). In some embodiments, the pockets 24 extending from opposite sides/ends may not be aligned. In some embodiments (see for example FIG. 12C), each pocket 24 extending from one of the ends of the rotor module 405 may extend no more than half of the overall length of the rotor module 405, such that there may be a portion of the active length in which the pockets 24 do not extend (e.g. a central portion of the active length of the rotor module 405 may not have pockets extending therein). In some embodiments, the plurality of pockets 24 may be evenly and/or symmetrically spaced around the drive shaft 220 and/or longitudinal axis 63 of the rotor module 405 (e.g. at each end of the rotor module 405), while in other embodiments the pockets 24 may not be evenly spaced. For example, the spacing of the plurality of pockets 24 may range from 60-120 degrees or 60-90 degrees.

Balance rods 73 (e.g. two balance rods) may be inserted into corresponding pockets in the rotor module 405 in order to balance the rotor module 405 (e.g. as discussed below in more detail). In some embodiments, two balance rods 73 can be inserted into two adjacent pockets 24 in order to balance the rotor module 405, while other pockets 24 of the rotor module 405 may remain empty (e.g. with no balance mass disposed therein). The specific adjacent pair of pockets 24 and the amount of balance mass for each may be selected in order to balance the rotor module 405 (e.g. to correct any inherent unbalance in the rotor module 405). For example, disclosed method embodiments may be used in the selection process (e.g. by determining a direction and a mass amount representing unbalance of the rotor module, which may be stated in the form of a vector of unbalance of the rotor module, and then using that to determine which pockets to select and the amount of mass to add to each selected pocket). In embodiments, the selection process can utilize a balance machine.

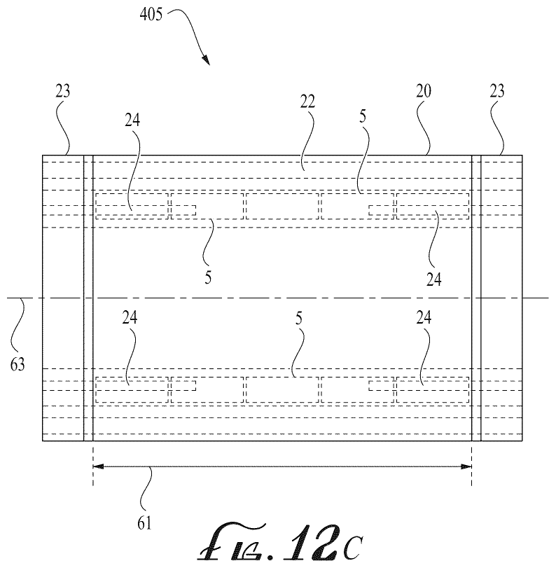

A similar approach (e.g. with pockets 24 extending axially into the active length 61 of the rotor module 405) may be used in other types of rotors (e.g. without permanent magnets) as well. In some alternative embodiments where magnets are not used, e.g. a synchronous reluctance motor (e.g. see FIG. 13) or a switch reluctance motor (e.g. see FIG. 14), but which also exhibit pole-based lamination design, a similar approach can be taken to create pockets 24 to form balance positions 6 which may be used to balance the rotor module 405 (e.g. by inserting two or more balance masses 73 into corresponding pockets 24).

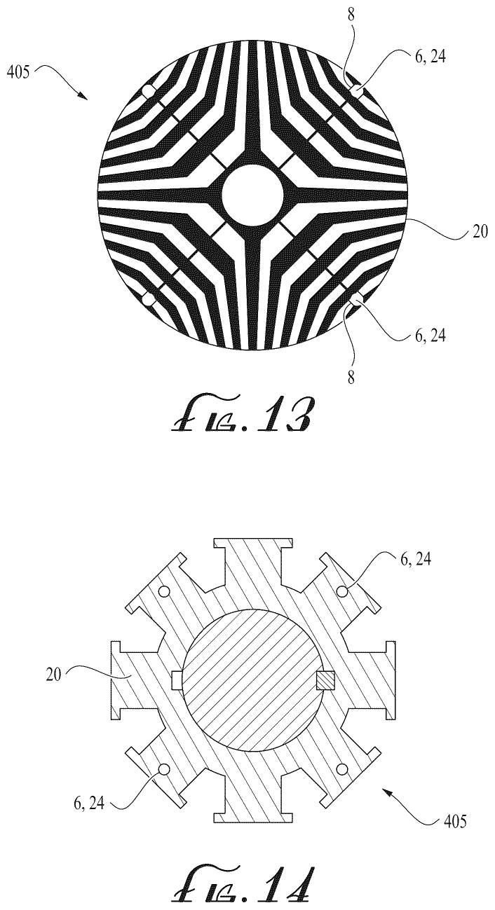

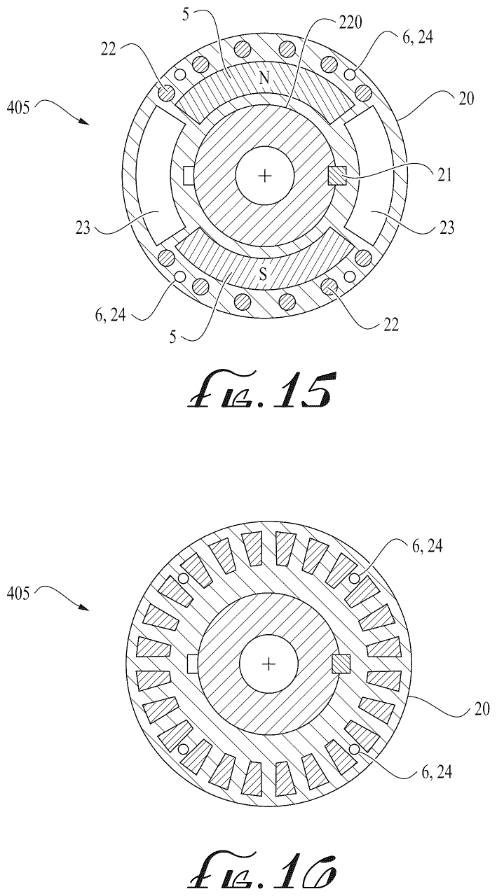

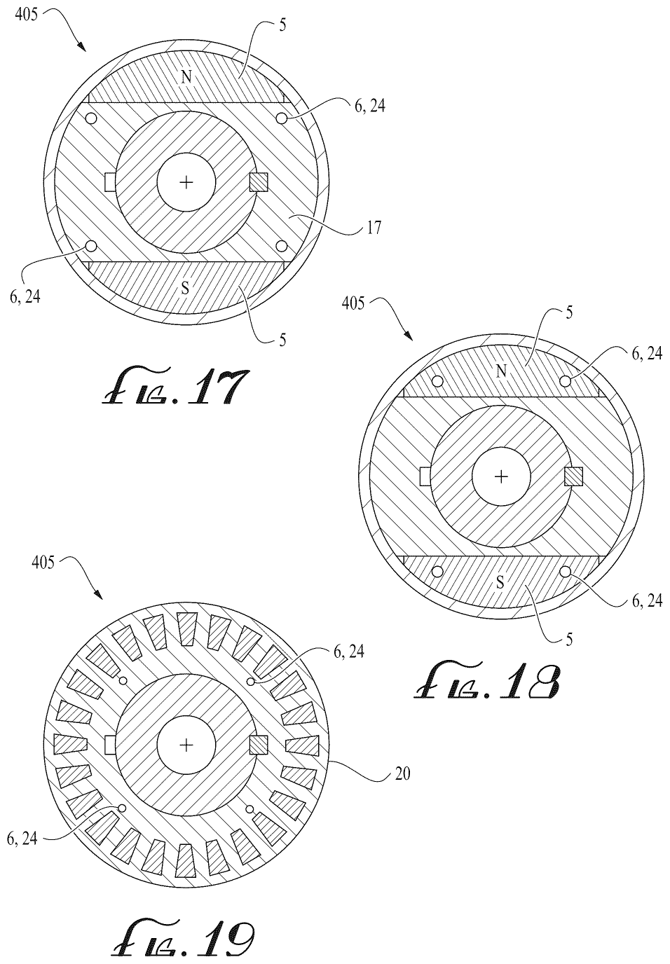

In some embodiments, as shown in FIGS. 15-19, the rotor can be a 2-pole PMM (or other 2 pole configuration) where the interpolar gaps only occur at 180°. This configuration may make the interpolar gaps unsuitable for balancing of the rotor module 405, as it does not offer a way of correcting for any arbitrary angle. To resolve this issue and recreate the four balance positions seen in earlier examples, the through holes (e.g. pockets 24 extending axially into the active length 61) may be disposed elsewhere in the rotor module 405. In some embodiments this can be done by adding an additional small hole to the lamination at a suitable angle, e.g. near the interpolar position, that minimizes a reduction in motor performance while meeting the requirements of usability for balancing. In a hybrid rotor PMM, this additional small hole(s) (e.g. pocket(s) 24) may be disposed between the rotor bars 22 (see for example FIG. 15). In the induction motor rotor module 405 of FIG. 16, the pockets 24 may be disposed between the rotor bars. In other embodiments, such as induction motors, the through holes (e.g. pockets 24) can be disposed in the drive shaft 220, in the magnet carrier 17, in the magnets 5, in the lamination stack 20 (e.g. anywhere within the lamination stack), etc., and/or at any interface between component parts (e.g. half of a hole in a magnet and half of a hole in the shaft). FIGS. 15-19 illustrate various exemplary locations for the pockets 24 and/or various exemplary types of rotor modules 405 in which pockets may be used for this approach.

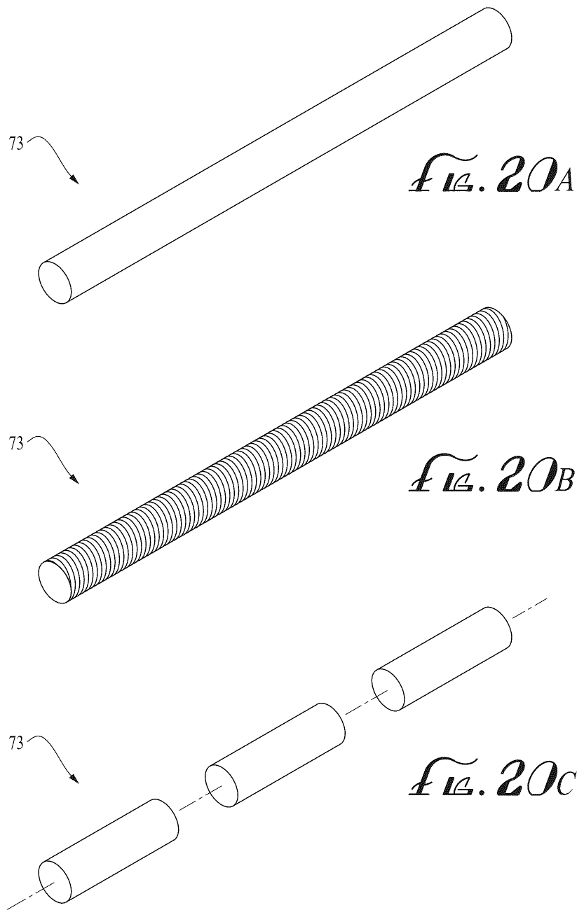

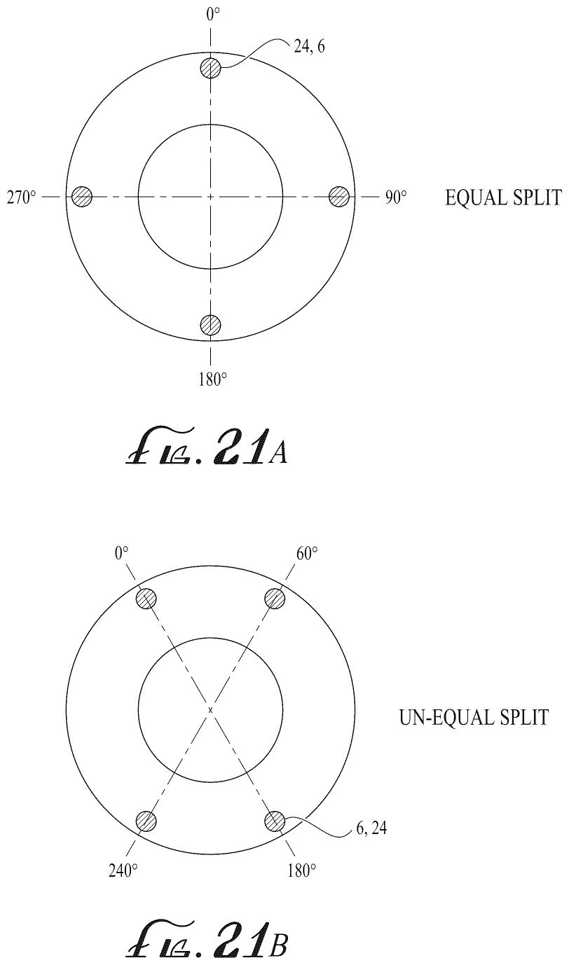

FIGS. 20A-C illustrate exemplary balance mass 73 embodiments. In some embodiments, the balance mass 73 can be of a round form (e.g. a solid rod, having a circular cross-section), as shown for example in FIG. 20A, however other cross-sectional shapes such as triangular, square, c-shaped and polygon are equally acceptable. In some configurations the balance mass 73 can also be threaded (see for example FIG. 20B), for example with threading on some portion of its length corresponding to threading in the pocket. Typically, the rod material of the balance mass 73 may be a non-magnetic material, such as a non-magnetic metal (e.g. any suitable metal such as stainless steel, copper, tungsten, titanium, tantalum, etc.), ceramic (e.g. tungsten carbide, alumina, zirconia) or other material.

In some embodiments, the rod material of the balance mass 73 may be magnetic if it does not significantly impact motor performance. Typically, the material for the balance mass 73 may be chosen for its density, for example to maximize/optimize the level of mass addition during the balancing process. In some embodiments, the rod of the balance mass 73 can be assembled as a single length, while in other embodiments (e.g. see for example FIG. 20C) the balance mass 73 can be subdivided into multiple shorter lengths which can jointly be built up to meet the overall requirement (e.g. jointly forming the balance mass 73).

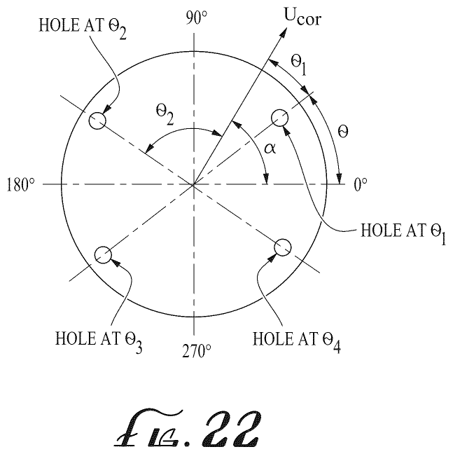

FIGS. 21A-B illustrate exemplary cases of four balance positions 6 (e.g. four pockets 24 extending through the entire length of the rotor module 405). In FIG. 21A, the balance positions 6 (e.g. pockets 24) can be disposed roughly at 90° intervals (e.g. with the pockets 24 spaced around the drive shaft 220 and/or axis 63 of the rotor module 405 by approximately 90 degrees). In other embodiments, the balance positions 6 (e.g. pockets 24) may be disposed with an un-equal split, for example with 60 degrees between some adjacent balance positions/pockets and 120 degrees between other adjacent balance positions/pockets. Four balance positions/pockets are often used, for simplicity of balancing calculations, but other numbers of balance positions are permitted (for example 3 balance positions is feasible but less practical, while 5 or more balance positions are mathematically more complex and less practical to use). With four balance positions/pockets (e.g. as shown in FIG. 21A), any combination of angle of balance can be created by using 2 adjacent balance positions/pockets (e.g. 0° and 90°, or 90° and 180°, or 180° and 270° or 270° and) 0° and then splitting the mass in each hole pair (e.g. pair of adjacent pockets 24) to set the vector sum of the correction to have the correct mass and angle between the two-hole pair (e.g.) 90°. In this example, rotating to the next hole pair may just add 90° to the angle of correction. As shown in FIG. 21B, it is not necessary for the spacing of the balance positions/pockets to all be regular, and in some embodiments the angle between hole pairs can vary (e.g. 0° and 60°, or 60° and 180°, or 180° and 240° or 240° and 0°, i.e. spacing of 60°, 120°, 60° and 120° respectively). In some embodiments, the spacing of the balance positions/pockets may be set for mathematical convenience for mass splitting calculations and/or for practical positioning in the rotor. In some embodiments, it is permitted to have more balance positions to increase capacity, but the calculation for splitting the mass becomes more complex.

Conceptually, the rotor module 405 can still be considered to have a balancing plane at each end, which essentially can correspond to half the rotor module 405 length. For example, each end portion of the rotor module 405 (e.g. up to the midpoint of the axial length) can be considered as acting as a conceptual balance plane. With such a conceptual balance plane at each end, the rotor module 405 can end up with two “halves” that make a whole rotor module length. For each of the halves, the pockets 24 and/or balance masses 73 could extend some portion (e.g. from the corresponding end up to the midpoint).

In some embodiments, if the balance mass 73 were to extend more than half of the rotor module length, the portion of the balance mass 73 longer than half of the rotor module length may be counterproductive (e.g. not able to assist in providing balance). Therefore in some embodiments, for each pocket 24, the maximum length of rod (e.g. balance mass 73) useable (e.g. per plane) may be half the rotor module 405 length and/or half the active length 61. For example, based on the previous 600 mm module example, the maximum rod length would be 300 mm. For the through hole add mass balance approach, the hardest case to correct may typically be where the unbalance correction angle is aligned to a pocket angle (e.g.) 0°. Here, the rod (e.g. balance mass 73) may still be utilized fully, i.e. it is correcting by 100% of its capacity to correct. By adding a second balance rod 73 to the next (e.g. adjacent) balance position (e.g.) 90°, the capacity to balance actually may increase to a maximum of ˜141% of the single balance rod, and therefore the rotor module 405 may become easier to correct. For a balance rod of the same diameter and material as discussed in the 24-hole balance plane example shown previously (e.g. FIG. 7C), the equivalent through hole method may require a balance rod of 230 mm long to achieve the same effect as the 24 hole balance plane. In this example, this leaves approximately 70 mm of further length to correct to a higher unbalance. In other words, the disclosed through hole add mass method may have approximately 30.6% more balance capacity, while not requiring any sacrifice in active length, assuming the same diameter and material. In some embodiments, the geometry may be restricted by other design factors and so this statement may not always hold true. In some embodiments, each balance mass 73 length may extend up to the full length of the rotor module 405, for example based on the specific unbalance of each end or conceptual balancing plane and/or the length of the corresponding pocket 24. So for example, each pocket 24 may have anywhere from no balance mass therein to a full length balance mass 73 rod disposed therein (e.g. the full length of the pocket 24 and/or the full length of the rotor module 405).

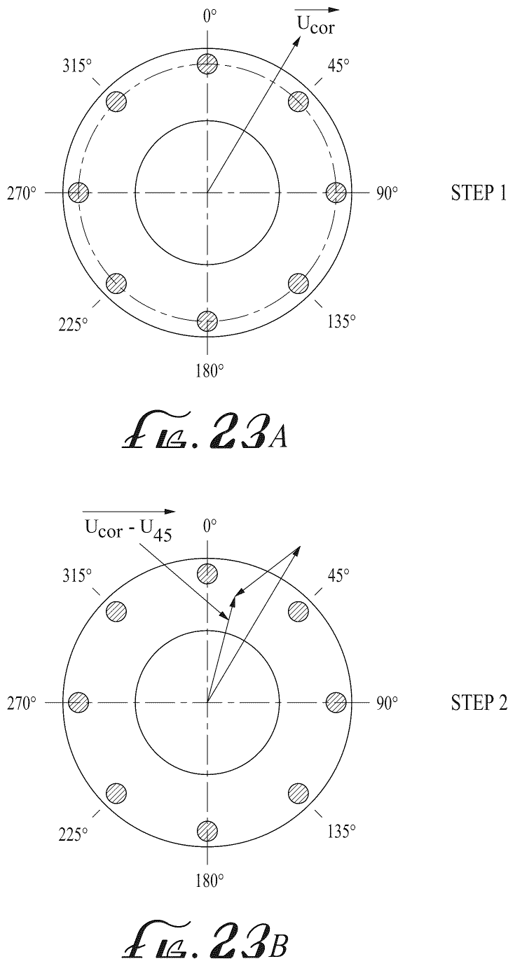

In order to determine the amount of mass and/or positioning (e.g. the corresponding pockets 24) for each of the two balance masses 73, a mass-splitting calculation may occur. The mass splitting on a four-balance position system can be mathematically straightforward. For example, two balance positions are assumed to be symmetric about an arbitrary 0° line as shown on FIG. 22, such that they are located at +0° (i.e. if θ=30°, one hole is at +30°, the second hole is at −30°). The remaining two balance positions are then rotated at ±[180+θ]° (i.e. if θ=30°, one hole is at +150°, the second hole is at −150°). The unbalance correction (U_{COR}) is then located at angle α from the 0° line.

The position of the balance positions/pockets can be made relative to the unbalance angle, so that in the positive angle sector (0° to) 180° the first hole at angle θ₁ and second hole at θ₂ lie at:

$${θ}_{1} = θ - α$$

$${θ}_{2} = 180 - θ - α$$

The unbalance split may then be a ratio of U_{COR} calculated where the unbalance in the hole at θ₁ is U₁ and the unbalance in the hole at θ₂ is U₂ as follows:

$${U}_{1} = {U}_{COR} / [ cos {θ}_{1} - \frac{sin {θ}_{1}}{sin {θ}_{2}} \cdot cos {θ}_{2} ]$$

$${U}_{2} = - {U}_{1} \cdot \frac{sin {θ}_{1}}{sin {θ}_{2}}$$

### Note:

If sin θ₂=0, then U₁=0 and U₂=U_{COR}
If U₁<0 then the mass is −U₁ and is moved 180° to the third hole at θ₃
If U₂<0 then the mass is −U₂ and is moved 180° to the fourth hole at θ₄

To derive a mass (m) from the unbalance we can divide U₁ and U₂ by the plane radius:

$${m}_{1} = {U}_{1} / r$$

$${m}_{2} = {U}_{2} / r$$

If the rod cross-section is constant, then the mass (m) is proportional to the length (L) and can be directly calculated by dividing through by the mass per unit length. Therefore U can be substituted with m or L depending on the input type (unbalance, mass or length) to the calculation, e.g. for length:

$${L}_{1} = {L}_{COR} / [ cos {θ}_{1} - \frac{sin {θ}_{1}}{sin {θ}_{2}} \cdot cos {θ}_{2} ]$$

$${L}_{2} = - {L}_{1} \cdot \frac{sin {θ}_{1}}{sin {θ}_{2}}$$

A similar substitution can be used for any other quantity based system, for example the number of short sections of rod, or number of dowels, or screw to be added to the balance position. This relies on the trial weight to be also based on a number of said quantity (e.g. 2× screws).

For higher pole counts (e.g. 8-pole), the equations are still valid, however the process becomes multi-stepped. The calculation can orient the balance positions so that the unbalance angle lies between the first pair of balance positions, for example the hole at 0° and 45° on FIGS. 23A-B. The balance positions at 0°, 45°, 180° and 225° become analogous to the balance positions in FIG. 22, where θ=22.5°, and the results are corrected for the angle difference (i.e. −θ=−22.5°). The calculation can then be used to calculate the lengths for step 1. If a mass required exceeds the maximum allowable capacity of the balance position (i.e. filled to the maximum length) the process may be repeated in a step 2. Here for example the mass in the hole at 45° is assumed at maximum length and has an unbalance effect U₄₅. The residual unbalance effect for this step can be calculated by deducting off U₄₅ from U_{COR}, noting this is a vector subtraction to get both magnitude and angle. In this example the balance positions are now at 0°, 90°, 180° and 270° per FIGS. 23A-B, and once again become analogous to the balance positions in FIG. 22, where θ=45°. The results of the calculation are then corrected for the angle difference (i.e. −θ0=−45°). In this manner, the calculation can repeat to determine what the split weights need to be, as either further balance positions become fully occupied or the desired correction is achieved.

The method of correction can include determining the required correction (e.g. the amount of mass and direction to correct the unbalance, which might be termed a correction vector). In embodiments, the method above may work to determine the unbalance correction in a single pass. For example, this may use a trial weight method consisting of three runs, operating at the same speed on the balance machine (or similar) as follows:
Run 1—Measure the rotors underlying unbalance (magnitude and phase angle) at both planes;
Run 2—Add a trial weight at the first balance position on plane 1 and then measure the rotors unbalance (magnitude and phase angle) at both planes; and
Run 3—Move trial weight to second balance position on plane 2 and then measure the rotors unbalance (magnitude and phase angle) at both planes.

A software based mathematical conversion can be used to then calculate the required unbalance correction directly. Beneficially, this process can typically achieve the desired correction on the first pass, ensuring the correct mass/length/unbalance is added to the plane on the first pass. This reduces what is potentially a complex balance process of a rotor module to a simple, quick, relatively unskilled process. If the tolerance is not achieved, the trial weight process can be repeated to get the rotor in to balance.

In some embodiments, the balance machine may determine correction vectors for each end of the rotor module. For simplicity, these two vectors can be combined to form an overall correction vector (e.g. for the rotor module as a whole) in some embodiments. Once the overall vector of correction is determined, the vector of correction (e.g. unbalance correction vector) can be split into two (or more) split vectors that would sum back up to be the same as the unbalance correction vector. The split vector then can describe the weight to be inserted into each selected pocket (e.g. based on the vector magnitude), noting that the angle part of the vector can correspond to the pocket angles. For example, the pockets may be selected so that the vector of correction extends between the selected pockets. Some balance machines may be configured to do more than simply determine the underlying unbalance of the rotor module and/or the vector of correction, and may actually provide the vector splits directly.

Although a balance machine has been described as an exemplary means of determining the underlying unbalance of the rotor module, alternative approaches may be used instead in some embodiments. In embodiments, any equivalent method or device that would give an indication of the underlying unbalance and/or the vector of correction would suffice. An example of such an alternate approach would be a set of vibration sensors, for example proximate to end/plane 1 and end/plane 2 of the rotor module. Such vibration sensors could be used with a once per revolution timing signal, which can then allow measurement of magnitude and phase of the vibration. In embodiments, the resulting “vibration vector” may be used in place of the unbalance vector (e.g. noting that the vibration vector can be the unbalance vector times a unit conversion factor). For example, a velocity style vibration sensor can be used. In embodiments, the results of the vibration sensor(s) can be converted back to velocity, and may indirectly allow the same thing to be achieved without the balance machine.

To hold the weight/mass (e.g. balance mass 73) in position, the weight needs to be prevented from moving. For example, this can be done by peening the pocket 24, for example at each end of the added weight (e.g. balance mass 73), to prevent axial movement. In other embodiments the weight (e.g. balance mass 73) can be bent to increase the insertion force or prevent a part of the weight entering the pocket 24. In other embodiments an additional part can be added to stop the weight moving.

Reducing unbalance, and thus the motor's vibration, can improve the run life of a downhole motor (or any other rotating equipment). The method and system for using balance masses extending into the active length of the rotor module 405 can provide a rapid and practical approach to reduce the unbalance of the rotor to a low level (e.g. ensuring that motor vibration meets ISO/API standards). This also can have benefits to the bearings of the rotor, which can operate better due to lower dynamic loads. Similarly, low rotor vibration can reduce the exciting forces that can reduce the magnitude of vibration where a rotor passes through a resonant mode, thus improving a machine's ability to operate at increasingly high speeds (e.g. 10000 rpm). Further, by maximizing the active length of the motor, the power factor and efficiency of the motor may be maximized. Additionally, rotor module balance can be achieved quickly using disclosed embodiments, for example typically achieving a low unbalance on the first pass, which may reduce the time to balance and hence reduce labor cost. These and other benefits may be provided by disclosed embodiments.

### Additional Disclosure

The following are non-limiting, specific embodiments in accordance with the present disclosure:

In a first embodiment, a rotor module configured to be concentrically disposed on a drive shaft (e.g. for an ESP motor) can comprise: an active length (e.g. configured for magnetic interaction with a corresponding stator, for example to drive the drive shaft, for example with the active length portion of the rotor module operating with the stator to generate torque); and a plurality of balance masses; wherein: the rotor module comprises a longitudinal centerline/axis configured to extend approximately parallel to the drive shaft, the active length extends longitudinally (e.g. axially, for example approximately parallel to the longitudinal centerline of the rotor module and/or the drive shaft), and the plurality of balance masses each extend longitudinally (e.g. axially, for example approximately parallel to the longitudinal centerline/axis of the rotor module and/or the drive shaft) into the active length of the rotor module (although in some alternate embodiments, the balance masses may extend into the active length non-axially, for example, not precisely parallel to the axis of the rotor module and/or shaft, but at some angle).

A second embodiment can include the rotor module of the first embodiment, wherein the plurality of balance masses are spaced around the drive shaft/axis (e.g. concentrically around the axis), for example with spacing between adjacent balance masses of approximately 60-120 degrees, approximately 60-90 degrees, approximately 45-90 degrees, approximately 45-120 degrees, or approximately 90 degrees.

A third embodiment can include the rotor module of the first or second embodiment, further comprising a plurality of pockets, each extending axially/longitudinally into the active length and each configured to retain one of the plurality of balance masses.

In a fourth embodiment, a rotor module configured to be concentrically disposed on a drive shaft (e.g. for an ESP motor) can comprise: an active length (e.g. configured for magnetic interaction with a corresponding stator, for example to drive the drive shaft, for example with the active length portion of the rotor module operating with the stator to generate torque); and a plurality of pockets, each extending axially/longitudinally into the active length (although in some alternate embodiments, the pockets may extend into the active length non-axially) and each configured to retain one of a plurality of balance masses; wherein: the active length extends longitudinally/axially (for example approximately parallel to the longitudinal centerline/axis of the rotor module and/or the drive shaft).

A fifth embodiment can include the rotor module of the fourth embodiment, further comprising one or more (e.g. a plurality of) balance masses each configured to fit with the pockets.

A sixth embodiment can include the rotor module of any one of the first to fifth embodiments, wherein each balance mass has a length no more than half the active length or no more than half the total/overall length of the rotor module.

A seventh embodiment can include the rotor module of any one of the third to sixth embodiments, wherein each pocket extends up to half of the length of the rotor module, at least half of the active length (e.g. up to the entirely of the active length or up to the entirety of the total/overall length of the rotor module). In some embodiments, each pocket can extend from the corresponding end of the rotor module up to half of the overall length of the rotor module (e.g. and if pockets on opposite sides of the rotor module are aligned, they can jointly form a total pocket length no more than the overall length of the rotor module).

An eighth embodiment can include the rotor module of any one of the third to seventh embodiments, wherein each pocket extends substantially the entirety of the active length or substantially the entirety of the total/overall length of the rotor module.

A ninth embodiment can include the rotor module of any one of the third to eighth embodiments, wherein the plurality of pockets are configured to be disposed around the drive shaft/longitudinal centerline/axis (e.g. concentrically around the axis).

A tenth embodiment can include the rotor module of any one of the third to ninth embodiments, wherein the plurality of pockets are evenly spaced around the drive shaft/longitudinal centerline/axis.

An eleventh embodiment can include the rotor module of any one of the third to ninth embodiments, wherein the plurality of pockets are unevenly and/or asymmetrically spaced around the drive shaft/longitudinal centerline/axis (for example some adjacent pockets spaced 60 degrees apart, while other adjacent pockets are spaced 120 degrees apart).

A twelfth embodiment can include the rotor module of any one of the ninth to eleventh embodiments, wherein spacing of the plurality of pockets around the drive shaft/longitudinal centerline/axis ranges from approximately 60-120 degrees, approximately 60-90 degrees, approximately 45-60 degrees, or approximately 45-90 degrees (e.g. between adjacent pockets, which may be circumferentially spaced around the axis).

A thirteenth embodiment can include the rotor module of any one of the ninth to tenth embodiments, wherein spacing of the plurality of pockets around the drive shaft/longitudinal centerline/axis is approximately 90 degrees (e.g. between adjacent pockets).

A fourteenth embodiment can include the rotor module of any one of the first to thirteenth embodiments, wherein the rotor module is configured to be keyed to the drive shaft (e.g. so that the rotor module rotates with the drive shaft, and vice versa).

A fifteenth embodiment can include the rotor module of any one of the first to fourteenth embodiments, wherein the active length comprises a plurality of permanent magnets (e.g. configured to be disposed around the drive shaft or disposed around the axis).

A sixteenth embodiment can include the rotor module of the fifteenth embodiment, further comprising a lamination stack configured to retain the plurality of permanent magnets, wherein the lamination stack is configured to be concentrically disposed about the drive shaft.

A seventeenth embodiment can include the rotor module of the sixteenth embodiment, wherein the plurality of pockets are disposed in the lamination stack.

An eighteenth embodiment can include the rotor module of any one of the fifteenth to seventeenth embodiments, further comprising a magnet carrier configured to be mounted on the drive shaft (and note, in some embodiments, the magnet carrier can be integral to the shaft).

A nineteenth embodiment can include the rotor module of the eighteenth embodiment, further comprising a retainer (e.g. configured to hold the magnets snuggly in place against the magnet carrier and/or configured to jointly, with the magnet carrier, hold the magnets in place in the rotor module).

A twentieth embodiment can include the rotor module of the nineteenth embodiment, wherein the retainer is configured to form an exterior of the rotor module (e.g. disposed concentrically around the other rotor elements and/or encompassing the other rotor elements).

A twenty-first embodiment can include the rotor module of any one of the eighteenth to twentieth embodiments, wherein a plurality of interpolar spaces/regions (e.g. axially extending) are formed between the carrier and the magnets (and in some embodiments, the retainer), and the pockets are disposed in the interpolar spaces.

A twenty-second embodiment can include the rotor module of the twenty-first embodiment, wherein one pocket is disposed in each interpolar space or a plurality of pockets are disposed per interpolar space.

A twenty-third embodiment can include the rotor module of any one of the twenty-first to twenty-second embodiments, wherein each interpolar space/region is configured to create a flux barrier (e.g. with the pockets disposed in the flux barriers).

A twenty-fourth embodiment can include the rotor module of the twenty-third embodiment, wherein each flux barrier comprises a solid non-magnetic insert disposed in the interpolar space/region (e.g. with the pocket disposed therein).

A twenty-fifth embodiment can include the rotor module of any one of the first to seventeenth embodiments, wherein (e.g. in an induction motor or a hybrid PMM motor) the active length comprises a plurality of rotor/cage bars (e.g. electrically connected to cage ends to form a squirrel cage for induction of magnetic field).

A twenty-sixth embodiment can include the rotor module of the twenty-fifth embodiment, further comprising a lamination stack configured to be concentrically disposed about the drive shaft or the axis, wherein the plurality of rotor/cage bars are disposed axially within the lamination stack and are configured to be concentrically disposed about the drive shaft or axis.

A twenty-seventh embodiment can include the rotor module of the twenty-sixth embodiment, wherein (e.g. in a hybrid PMM motor) permanent magnets may also be held in place by the lamination stack (e.g. the lamination stack may be configured to hold both the rotor/cage bars and the permanent magnets, and/or the active length may comprise the magnets, as well as the rotor/cage bars).

A twenty-eighth embodiment can include the rotor module of any one of the twenty-sixth to twenty-seventh embodiments, wherein the plurality of pockets are disposed in the lamination stack.

A twenty-ninth embodiment can include the rotor module of any one of the twenty-sixth to twenty-eighth embodiments, wherein a plurality of interpolar spaces/regions (e.g. axially extending) are formed in the lamination stack, and the pockets are disposed in the interpolar spaces (although note, the number of interpolar spaces does not need to match the number of balance masses/pockets—for example some interpolar spaces may not have a pocket and/or balance mass and/or some interpolar spaces may include two or more pockets and/or balance masses).

A thirtieth embodiment can include the rotor module of the twenty-ninth embodiment, wherein one pocket is disposed per interpolar space or a plurality of pockets are disposed per interpolar space.

A thirty-first embodiment can include the rotor module of any one of the twenty-ninth to thirtieth embodiments, wherein each interpolar space/region is configured to create a flux barrier (e.g. with the pockets disposed in the flux barriers).

A thirty-second embodiment can include the rotor module of the thirty-first embodiment, wherein each flux barrier comprises a solid, non-magnetic insert disposed in the corresponding interpolar space (e.g. with a pocket disposed therein).

A thirty-third embodiment can include the rotor module of any one of the twenty-first to twenty-fourth or twenty-ninth to thirty-second embodiments, wherein each interpolar space comprises non-magnetic material.

A thirty-fourth embodiment can include the rotor module of any one of the third to thirty-third embodiments, wherein one or more of the pockets may be formed in the magnets, the magnet carrier, the drive shaft, the lamination stack, and/or any interface between component parts of the rotor module.

A thirty-fifth embodiment can include the rotor module of any one of the first to thirty-fourth embodiments, wherein each balance mass comprises a solid rod (e.g. having a cross-section that is circular, triangular, square, polygonal, diamond, vee-shaped, c-shaped, etc.).

A thirty-sixth embodiment can include the rotor module of any one of the first to thirty-fifth embodiments, wherein each balance mass has an approximately constant cross-section (e.g. its cross-section does not vary along its length).

A thirty-seventh embodiment can include the rotor module of any one of the first to thirty-sixth embodiments, wherein the balance masses are threaded (and for example, the pockets may have corresponding threads, allowing the balance masses to be screwed into the corresponding pocket).

A thirty-eighth embodiment can include the rotor module of any one of the first to thirty-seventh embodiments, wherein each balance mass comprises non-magnetic materials (e.g. stainless steel, copper, tungsten, titanium, tantalum, and/or ceramic (such as tungsten carbine, alumina, zirconia).

A thirty-ninth embodiment can include the rotor module of any one of the first to thirty-seventh embodiments, wherein the balance masses may be magnetic.

A fortieth embodiment can include the rotor module of any one of the first to thirty-ninth embodiments, wherein each balance mass comprises a dense material (e.g. 7650 kg/mm³ to 19250 kg/mm³).

A forty-first embodiment can include the rotor module of any one of the first to fortieth embodiments, wherein each balance mass comprises a plurality of balance mass segments (which jointly can form the length of the balance mass).

A forty-second embodiment can include the rotor module of the forty-first embodiment, wherein the balance mass segments of each balance mass may be axially linked (for example via screw threads) (although in other embodiments each balance mass may be formed by stacking a plurality of balance mass segments into the same pocket).

A forty-third embodiment can include the rotor module of any one of the first to forty-second embodiments, wherein all of the balance masses comprise the same material (but in other embodiments, different balance masses may comprise different materials (e.g. not all balance masses may be identical)).

A forty-fourth embodiment can include the rotor module of any one of the third to forty-third embodiments, wherein each pocket (e.g. cross-section) corresponds to a balance mass in shape and size (e.g. so as to be configured to snuggly retain the corresponding balance mass).

A forty-fifth embodiment can include the rotor module of any one of the first to forty-fourth embodiments, wherein there are no more than two balance masses within the rotor module (although in embodiments in which one of the pockets requires more mass to balance than can be held in that pocket, a third balance mass may be added to the other adjacent pocket).

A forty-sixth embodiment can include the rotor module of any one of the third to forty-fifth embodiments, wherein there are four or more pockets (for example, four pockets, 4-8 pockets, or alternately in some embodiment 3-8 pockets).

A forty-seventh embodiment can include the rotor module of any one of the third to forty-sixth embodiments, wherein not all pockets have a balance mass disposed therein (e.g. when the rotor module is balanced, some pockets are empty—for example, the rotor module may have four pockets, but may have balance masses disposed within only two of the pockets, for example based on a determination of which adjacent pocket pair can balance the rotor module).

A forty-eighth embodiment can include the rotor module of any one of the first to forty-seventh embodiments, wherein the balance masses (e.g. disposed in their corresponding pockets) each have a different mass (e.g. a different length, based on a determination of the amount of mass needed in a specific pocket of the rotor module to balance the rotor module).

A forty-ninth embodiment can include the rotor module of any one of the first to forty-eighth embodiments, wherein the balance masses serve no function other than balancing of the rotor module.

A fiftieth embodiment can include the rotor module of any one of the first to forty-ninth embodiments, wherein each balance mass is fixed in axial position within the corresponding pocket (e.g. with its end peened or otherwise via peening).

In a fifty-first embodiment, a rotor (e.g. for an ESP motor) can comprise a plurality of rotor modules concentrically disposed on a drive shaft, wherein each rotor module comprises one of the first to fiftieth embodiments (e.g. wherein the plurality of rotor modules are stacked axially on the drive shaft (in some embodiments with radial bearings disposed therebetween) and/or are fixed to the shaft so that the shaft and the rotor modules rotate as one).

A fifty-second embodiment can include the rotor of the fifty-first embodiment, wherein each of the rotor modules is balanced (e.g. sufficiently to meet a standard).

In a fifty-third embodiment, an ESP assembly comprises an electric motor coupled to a pump, wherein any one of the rotor modules or rotors of the first to fifty-second embodiments are in the motor.

In a fifty-fourth embodiment, a system comprising the ESP assembly of the fifty-third embodiment disposed downhole in a well.

In a fifty-fifth embodiment, a method of balancing a rotor module, having a plurality of pockets extending (e.g. axially) into an active length of the rotor module, can comprise: determining an underlying unbalance of the rotor module (e.g. a vector of unbalance/imbalance of the rotor module, for example with the vector comprising a direction (e.g. phase angle) and a mass amount/magnitude); based on the underlying unbalance (e.g. the vector of unbalance/imbalance), determining the pockets (e.g. which of the plurality of pockets) for receiving balance masses and an amount of each balance mass for the corresponding pocket (e.g. to counter/offset the unbalance/imbalance); and inserting the balance masses into the corresponding pockets (e.g. based on the determination of the pockets for receiving balance masses and the amount of each balance mass for the corresponding pocket) in order to balance the rotor module. In some embodiments, determining a vector of unbalance of the rotor module may comprise determining a vector of unbalance per rotor module end (e.g. per conceptual balancing plane).

A fifty-sixth embodiment can include the method of the fifty-fifth embodiment, further comprising providing the rotor module with the plurality of axially extending pockets.

A fifty-seventh embodiment can include the method of any one of the fifty-fifth to fifty-sixth embodiments, further comprising providing the balance masses based on the determination of the amount of each balance mass.

A fifty-eighth embodiment can include the method of any one of the fifty-fifth to fifty-seventh embodiments, further comprising verifying balance of the rotor module after insertion of the balance masses into the corresponding pockets (e.g. to ensure balance of the rotor module meets a standard, for example within tolerance).

A fifty-ninth embodiment can include the method of any one of the fifty-fifth to fifty-eighth embodiments, wherein determining underlying unbalance of the rotor module (e.g. the vector of unbalance/imbalance) comprises using a balance machine or equivalent/alternate (such as vibrational measurement, for example by vibration sensors proximate to the two ends of the rotor module) to evaluate (e.g. measure) unbalance/imbalance of the rotor module (e.g. the magnitude/amount of mass of the imbalance and the direction of the imbalance).

A sixtieth embodiment can include the method of the fifty-ninth embodiment, wherein using a balance machine to evaluate unbalance/imbalance of the rotor module comprises: measuring, with the balance machine, an underlying unbalance of the rotor module (e.g. at both ends/planes); adding a trial weight at a first one of the plurality of holes at a first end/plane of the rotor module, and measuring unbalance/imbalance (of the rotor module with the trial weight at the first hole at the first end/plane) with the balance machine (e.g. at both ends/planes); moving the trial weight to a second one of the plurality of holes at a second end/plane of the rotor module, and measuring unbalance/imbalance (of the rotor module with the trial weight at the second hole at the second end/plane) with the balance machine (e.g. at both ends); and using the measurements to calculate the unbalance/imbalance correction (e.g. the vector of unbalance/imbalance, from which the correction vector (e.g. the counter/offset vector) can be determined, and/or directly the vector of unbalance correction of the rotor module) (e.g. by simultaneous equations, vector mathematics, and/or matrix mathematics, or some equivalent).

A sixty-first embodiment can include the method of the sixtieth embodiment, wherein using the measurements to calculate the unbalance/imbalance correction comprises using a software-based mathematical conversion (e.g. typically achieving the desired balance results on the first pass).

A sixty-second embodiment can include the method of any one of the fifty-eighth to sixty-first embodiments, wherein verifying the balance of the rotor module comprises using a balance machine or equivalent/alternate to check balance of the rotor module.

A sixty-third embodiment can include the method of any one of the fifty-seventh to sixty-second embodiments, wherein providing the balance masses comprises forming each balance mass with an appropriate amount of mass based on the determination of the amount of each balance mass.

A sixty-fourth embodiment can include the method of the sixty-third embodiment, wherein forming each balance mass comprises removing mass (e.g. grinding or shaving) from pre-formed masses (e.g. in some embodiments a set of pre-formed masses may initially all have approximately the same mass and/or length, with mass (e.g. length) being removed from each as needed during the balancing process).

A sixty-fifth embodiment can include the method of any one of the sixty-third to sixty-fourth embodiments, wherein forming each balance mass comprises selecting a material density for the balance masses (e.g. for each balance mass).

A sixty-sixth embodiment can include the method of any one of the fifty-seventh to sixty-second embodiments, wherein providing the balance masses comprises selecting each balance mass from a plurality (e.g. a set) of pre-formed masses (e.g. of different mass amounts and/or densities and/or lengths) and/or building up the correct amount of mass for each balance mass using balance mass segments.

A sixty-seventh embodiment can include the method of any one of the fifty-eighth to sixty-sixth embodiments, further comprising, responsive to verification of the balance of the rotor module demonstrating that the standard has not been met, (e.g. iteratively) rebalancing the rotor module.

A sixty-eighth embodiment can include the method of the sixty-seventh embodiment, wherein rebalancing the rotor module comprises: determining a vector of unbalance/imbalance of the rotor module with the (e.g. initial) balance masses inserted into the corresponding pockets; based on the vector of unbalance/imbalance of the rotor module with the (e.g. initial) balance masses inserted into the corresponding pockets, modifying the balance masses in order to balance the rotor module; and re-verifying balance of the rotor module after insertion of the modified balance masses into the corresponding pockets (e.g. to ensure balance meets the standard).

A sixty-ninth embodiment can include the method of any one of the fifty-fifth to sixty-sixth embodiments, wherein balance of the rotor module meets the standard using initial balance masses (e.g. without any modification of initial balance masses (e.g. after insertion into the rotor module), without further iteration, and/or without rebalancing (e.g. after insertion of the initial balance masses into the rotor module and/or after verifying the balance of the rotor module)) (e.g. wherein only two balance masses may be used in the pockets to balance the rotor module).

A seventieth embodiment can include the method of any one of the sixty-seventh to sixty-eighth embodiments, wherein rebalancing occurs no more than once to meet the standard (e.g. no more than one round of modification of the initial balance masses to meet the standard).

A seventy-first embodiment can include the method of any one of the fifty-fifth to seventieth embodiments, wherein determining the pockets for receiving balance masses and an amount of each balance mass uses no more than two of the plurality of pockets (e.g. two of four available pockets) and/or no more than two balance masses (although in embodiments in which one of the pockets requires more mass to balance than can be held in that pocket, a third balance mass may be added to the other adjacent pocket, as discussed below).

A seventy-second embodiment can include the method of any one of the fifty-fifth to seventy-first embodiments, wherein determining the pockets for receiving balance masses uses two adjacent pockets (e.g. an adjacent pair of pockets, disposed in proximity to one another).

A seventy-third embodiment can include the method of any one of the fifty-fifth to seventy-second embodiments, wherein the pockets (e.g. adjacent pockets) are spaced apart around the drive shaft and/or axis of the rotor module by approximately 90 degrees.

A seventy-fourth embodiment can include the method of any one of the fifty-fifth to seventy-second embodiments, wherein spacing of the pockets (e.g. adjacent pockets) around the drive shaft and/or axis of the rotor module ranges from approximately 60 to 120 degrees, approximately 45-60 degrees, approximately 45-90 degrees, approximately 45-120 degrees, approximately 60-90 degrees, or approximately 90 to 120 degrees.

A seventy-fifth embodiment can include the method of any one of the fifty-fifth to seventy-fourth embodiments, wherein the rotor module comprises 3-8 pockets (e.g. typically four).

A seventy-sixth embodiment can include the method of any one of the fifty-fifth to seventy-fifth embodiments, wherein determining the pockets for receiving balance masses comprises selecting adjacent pockets of the rotor module.

A seventy-seventh embodiment can include the method of any one of the fifty-fifth to seventy-sixth embodiments, wherein determining the pockets for receiving balance masses and an amount of each balance mass for the corresponding pocket (e.g. to counter/offset the underlying rotor unbalance/imbalance) is based on vector (e.g. mathematics) calculations (e.g. vector splitting) (e.g. which may include simultaneous equations, vector mathematics, matrix mathematics, and/or some equivalent).

A seventy-eighth embodiment can include the method of any one of the fifty-fifth to seventy-seventh embodiments, wherein determining the pockets for receiving balance masses and the amount of each balance mass for the corresponding pocket based on the vector of unbalance/imbalance comprises determining a counter/offset vector based on the vector of unbalance/imbalance (e.g. with the counter/offset vector having equal mass to the vector of unbalance/imbalance, but having a direction opposite that of the vector of unbalance/imbalance) (and note, in some embodiments, the balance machine may directly determine a vector of unbalance correction, in which case this seventy-eighth embodiment may comprise determining the pockets for receiving balance masses and the amount of each balance mass for the corresponding pocket based on the vector of unbalance correction (e.g. with the correction vector sum acting to counter/offset the underlying unbalance of the rotor module), and in some embodiments may further comprise selecting adjacent pockets in proximity to the vector of unbalance correction (e.g. bounding the angles of the split vector to be proximate to the vector of unbalance correction and/or with the vector of unbalance correction direction disposed therebetween)).

A seventy-ninth embodiment can include the method of the seventy-eighth embodiment, wherein determining the pockets for receiving balance masses further comprises selecting adjacent pockets of the rotor module in proximity to the counter/offset vector (e.g. bounding the direction of the counter/offset vector and/or with the counter/offset vector direction disposed therebetween).

An eightieth embodiment can include the method of the seventy-ninth embodiment, wherein determining an amount of each balance mass for the corresponding pocket comprises splitting the mass of the counter/offset vector (or the vector) between the selected adjacent pockets (e.g. so that when the split masses at those locations are vector summed, they result in the counter/offset vector calculated to balance the inherent unbalance of the rotor module).

An eighty-first embodiment can include the method of any one of the fifty-fifth to eightieth embodiments, wherein responsive to determining that the amount of the balance mass for one or more pocket (e.g. to counter/offset the unbalance/imbalance) cannot fit within the corresponding pocket: inserting the balance mass for the specific one or more pocket at maximum mass; determining an amount of balance mass for an (e.g. another) adjacent pocket (e.g. opposite the other, initial adjacent pocket) configured to address the excess amount of balance mass to balance the rotor module (e.g. the amount of mass beyond that which would fit in the one or more pocket); and inserting the balance mass configured to address excess into the adjacent pocket.

An eighty-second embodiment can include the method of the eighty-first embodiment, wherein determining the amount of excess balance mass is based on vector calculations (e.g. vector splitting).

An eighty-third embodiment can include the method of any one of the fifty-fifth to eighty-second embodiments, wherein each of the pockets extends axially into the active length of the rotor module (e.g. from half to an entire length of the rotor module (e.g. typically the entire length of the rotor module)).

An eighty-fourth embodiment can include the method of any one of the fifty-fifth to eighty-third embodiments, wherein each balance mass has a length no more than half that of the rotor module.

An eighty-fifth embodiment can include the method of any one of the fifty-fifth to eighty-fourth embodiments, further comprising fixing (e.g. via peening, etc.) the balance masses in the corresponding pockets.

An eighty-sixth embodiment can include the method of any one of the fifty-fifth to eighty-fifth embodiments, wherein no balance planes (e.g. no added length or sections) are added to the ends of the rotor module or add to the axial length of the rotor module (e.g. the rotor modules are balanced without adding weight to balance planes outside of the active length of the rotor module and/or wherein the rotor module is balanced while minimizing length of the rotor module and/or maximizing the ratio of active length versus total length of the rotor module).

An eighty-seventh embodiment can include the method of any one of the fifty-fifth to eighty-sixth embodiments, wherein the rotor module comprises any one of the first to fiftieth embodiments.

In an eighty-eighth embodiment, a method of balancing a rotor module can comprise inserting one or more balance masses into the rotor module, wherein the one or more balance masses each extend (e.g. axially) into an active length of the rotor module.

An eighty-ninth embodiment can include the method of the eighty-eighth embodiment, wherein the rotor module comprises a plurality of pockets extending (e.g. axially) into the active length of the rotor module, wherein inserting one or more balance masses into the rotor module comprises inserting the one or more balance masses into corresponding pockets.

A ninetieth embodiment can include the method of the eighty-ninth embodiment, wherein the plurality of pockets are disposed (e.g. concentrically) around the drive shaft and/or an axis of the rotor module.

A ninety-first embodiment can include the method of any one of the eighty-ninth to ninetieth embodiments, further comprising determining the pockets (e.g. which of the plurality of pockets) for receiving balance masses and an amount of each balance mass for the corresponding pocket (e.g. to counter/offset the unbalance/imbalance of the rotor module).

A ninety-second embodiment can include the method of the ninety-first embodiment, wherein determining the pockets (e.g. which of the plurality of pockets) for receiving balance masses and an amount of each balance mass for the corresponding pocket (e.g. to counter/offset the unbalance/imbalance) comprises using a balance machine.

A ninety-third embodiment can include the method of any one of the eighty-ninth to ninety-second embodiments, wherein the rotor module comprises 3-8 (e.g. typically four) pockets.

A ninety-fourth embodiment can include the method of any one of the eighty-eighth to ninety-third embodiments, wherein (e.g. only or no more than) two balance masses are inserted into the rotor module to balance the rotor module to a standard (e.g. within a tolerance).

A ninety-fifth embodiment can include the method of any one of the eighty-eighty to ninety-fourth embodiments, wherein the rotor module comprises one of the first to fiftieth embodiments.

In a ninety-sixth embodiment, a method of forming a rotor of an ESP can comprise: balancing a plurality of rotor modules (e.g. wherein each of the plurality of rotor modules comprises one of the first to fiftieth embodiments) using one of the fifty-fifth to ninety-fifth method embodiments; and disposing the plurality of balanced rotor modules concentrically on a drive shaft.

A ninety-seventh embodiment can include the method of the ninety-sixth embodiment, further comprising fixing the rotor modules to the shaft (e.g. so that the rotor modules and drive shaft rotate together).

In a ninety-eighth embodiment, a method of operating an ESP assembly (e.g. similar to the fifty-third embodiment above), comprising: using the method of any one of the fifty-fifth to ninety-fifth embodiments for a plurality of rotor modules; disposing the plurality of balanced rotor modules concentrically on the drive shaft of an electric motor (e.g. axially stacking the rotor modules and/or and fixing their rotational position with respect to the drive shaft); disposing a stator concentrically around the plurality of rotor modules; coupling the drive shaft to a pump to form the ESP assembly; electrically connecting the stator and/or rotor to a power source for operation of the motor; disposing the ESP assembly downhole in a well; and/or using the ESP assembly to pump fluid uphole (e.g. towards the surface).

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A rotor module configured to be concentrically disposed on a drive shaft for an ESP motor, comprising:
an active length; and
a plurality of pockets, each extending axially into the active length and each configured to retain one of a plurality of balance masses.

2. The rotor module of claim 1, further comprising the plurality of balance masses, each configured to fit within one of the pockets.

3. The rotor module of claim 2, wherein each balance mass has a length which is no more than half of an overall length of the rotor module.

4. The rotor module of claim 3, wherein each pocket extends at least half the overall length, but no more than the overall length of the rotor module.

5. The rotor module of claim 1, wherein each pocket extends substantially an overall length of the rotor module.

6. The rotor module of claim 1, wherein the plurality of pockets are disposed around an axis of the rotor module.

7. The rotor module of claim 6, wherein the plurality of pockets comprises four pockets, and spacing of the four pockets around the axis is approximately 90 degrees.

8. The rotor module of claim 6, wherein the active length comprises a plurality of permanent magnets disposed around the axis, the rotor module further comprises a magnet carrier configured to be mounted on the drive shaft, a plurality of interpolar spaces are formed between the magnet carrier and the permanent magnets, and the pockets are disposed in the interpolar spaces.

9. The rotor module of claim 6, wherein the active length comprises a plurality of rotor bars, the rotor module further comprises a lamination stack configured to be concentrically disposed about the axis, the plurality of rotor bars are disposed axially within the lamination stack and are configured to be concentrically disposed about the axis, and the plurality of pockets are disposed in the lamination stack.

10. The rotor module of claim 2, wherein each balance mass comprises a solid rod of non-magnetic material.

11. A method of balancing a rotor module having a plurality of pockets extending axially into an active length of the rotor module, comprising:
determining a vector of unbalance of the rotor module;
based on the vector of unbalance, determining specific pockets of the plurality of pockets for receiving balance masses and an amount of each balance mass for the corresponding specific pocket; and
inserting the balance masses into the corresponding specific pockets in order to balance the rotor module.

12. The method of claim 11, further comprising providing the balance masses based on the determination of the amount of each balance mass.

13. The method of claim 11, further comprising verifying balance of the rotor module after insertion of the balance masses into the corresponding specific pockets.

14. The method of claim 11, wherein determining the vector of unbalance comprises using a balance machine to evaluate unbalance of the rotor module.

15. The method of claim 14, wherein using a balance machine to evaluate unbalance of the rotor module comprises:
measuring, with the balance machine, an underlying unbalance of the rotor module at both ends;
adding a trial weight at a first one of the plurality of holes at a first end of the rotor module, and measuring unbalance with the balance machine;
moving the trial weight to a second one of the plurality of holes at a second end of the rotor module, and measuring unbalance with the balance machine; and
using the measurements to calculate unbalance correction of the rotor module.

16. The method of claim 11, wherein the rotor module comprises 3-8 pockets, determining the specific pockets for receiving balance masses selects only two adjacent pockets of the 3-8 pockets, and only two balance masses are used to balance the rotor module.

17. The method of claim 11, wherein determining specific pockets for receiving balance masses and an amount of each balance mass for the corresponding specific pocket is based on vector mathematic calculations.

18. The method of claim 11, wherein determining specific pockets for receiving balance masses and an amount of each balance mass for the corresponding specific pocket based on the vector of unbalance comprises determining a counter vector based on the vector of unbalance, with the counter vector having equal mass to the vector of unbalance but having a direction opposite that of the vector of unbalance.

19. The method of claim 18, wherein determining specific pockets for receiving balance masses further comprises selecting adjacent pockets of the rotor module in proximity to the counter vector.

20. The method of claim 19, wherein determining an amount of each balance mass for the corresponding specific pocket comprises splitting the mass of the counter vector between the selected adjacent pockets.
